(19) United States
(12) Patent Application Publication
(10) Pub. No.: US 2025/0201478 A1
(43) Pub. Date: Jun. 19, 2025

(54) CAPACITOR AND POWER SOURCE MODULE

(71) Applicant: Panasonic Intellectual Property Management Co., Ltd., Osaka (JP)

(72) Inventors: Kenichi ASANUMA, Osaka (JP); Koji TAKAHASHI, Kanagawa (JP); Kazuaki AOYAMA, Aichi (JP); Shoji YOSHIDA, Kanagawa (JP)

(21) Appl. No.: 18/846,564

(22) PCT Filed: Mar. 9, 2023
(86) PCT No.: PCT/JP2023/009043

§ 371 Date: Sep. 12, 2024

(30) Foreign Application Priority Data
Mar. 15, 2022 (JP) 2022-040815

(51) Int. Cl. H01G 4/232; H01G 4/012; H01G 4/224; H01G 4/30; H01G 9/008; H01G 9/048; H01G 9/08; H02M 3/06

(52) U.S. Cl. CPC H01G 4/232; H01G 4/012; H01G 4/224; H01G 9/008; H01G 9/048; H01G 9/08; H01G 4/30; H02M 3/06

(57) ABSTRACT

In a capacitor, first metal layers are connected to a first external electrode, and disposed away from a second external electrode. Second metal layers are connected to the second external electrode, and disposed away from the first external electrode. Third metal layers are connected to a third external electrode, and disposed away from a fourth external electrode. Fourth metal layers are connected to the fourth external electrode, and disposed away from the third external electrode. In metal layers, each of the first metal layers is disposed in a first direction adjacent to at least one metal layer selected form a group consisting of the third metal layers and the fourth metal layers, and each of the third metal layers is disposed in the first direction adjacent to at least one metal layer selected form a group consisting of the first metal layers and the second metal layers.

### TECHNICAL FIELD

The present disclosure generally relates to capacitors and power source modules. More particularly, the present disclosure relates to a capacitor including a plurality of external electrodes, and a power source module including the capacitor.

### BACKGROUND ART

As a conventional capacitor, an electrolytic capacitor has been known which includes an element layered body where a plurality of capacitor elements are layered, a first external electrode, a second external electrode and a third external electrode (refer to e.g., Patent Literature 1).

The capacitor may be needed to have a lower impedance.

### CITATION LIST

### Patent Literature

Patent Literature 1: WO 2021/085555 A1

### SUMMARY OF INVENTION

It is therefore an object of the present disclosure to provide a capacitor and a power source module, all of which can contribute to achieving a lower impedance.

A capacitor according to an aspect of the present disclosure includes a layered body, a first external electrode, a second external electrode, a third external electrode and a fourth external electrode. The layered body includes a plurality of metal layers and a plurality of dielectric layers. The plurality of metal layers and the plurality of dielectric layers are alternately arranged in a first direction. The first external electrode and the second external electrode are disposed to face each other with the layered body being interposed between the first external electrode and the second external electrode in a second direction orthogonal to the first direction. The third external electrode and the fourth external electrode are disposed to face each other with the layered body being interposed between the third external electrode and the fourth external electrode in a third direction orthogonal to both the first direction and the second direction. The plurality of metal layers include a plurality of first metal layers, a plurality of second metal layers, a plurality of third metal layers and a plurality of fourth metal layers. The plurality of first metal layers are connected to the first external electrode, and disposed away from the second external electrode. The plurality of first metal layers are arranged apart from each other in the first direction. The plurality of second metal layers are connected to the second external electrode, and disposed away from the first external electrode. The plurality of second metal layers are arranged apart from each other in the first direction. The plurality of third metal layers are connected to the third external electrode, and disposed away from the fourth external electrode. The plurality of third metal layers are arranged apart from each other in the first direction. The plurality of fourth metal layers are connected to the fourth external electrode, and disposed away from the third external electrode. The plurality of fourth metal layers are arranged apart from each other in the first direction. In the plurality of metal layers, the plurality of first metal layers and the plurality of second metal layers are arranged in the first direction, and the plurality of third metal layers and the plurality of fourth metal layers are arranged in the first direction. In the plurality of metal layers, each of the plurality of first metal layers is disposed in the first direction adjacent to at least one metal layer selected form a group consisting of the plurality of third metal layers and the plurality of fourth metal layers. In the plurality of metal layers, each of the plurality of third metal layers is disposed in the first direction adjacent to at least one metal layer selected form a group consisting of the plurality of first metal layers and the plurality of second metal layers.

A capacitor according to an aspect of the present disclosure includes a layered body, a plurality of first external electrodes and a plurality of second external electrodes. The layered body includes a plurality of metal layers and a plurality of dielectric layers. The plurality of metal layers and the plurality of dielectric layers are alternately arranged in a thickness direction of the layered body. All of the plurality of first external electrodes and the plurality of second external electrodes are disposed to penetrate the layered body in the thickness direction of the layered body. The plurality of metal layers includes a plurality of first metal layers and a plurality of second metal layers. The plurality of first metal layers are connected to the plurality of first external electrodes, and disposed away from the plurality of second external electrodes. The plurality of first metal layers are arranged apart from each other in the thickness direction of the layered body. The plurality of second metal layers are connected to the plurality of second external electrodes, and disposed away from the plurality of first external electrodes. The plurality of second metal layers are arranged apart from each other in the thickness direction of the layered body. In the plurality of metal layers, the plurality of first metal layers and the plurality of second metal layers are arranged alternately on a layer-by-layer basis in the thickness direction of the layered body.

A power source module according to an aspect of the present disclosure includes a DC/DC converter, an inductor, and any one of the capacitors according to the aspects described above. The inductor is connected to an output end of the DC/DC converter. The capacitor is connected between ground and a wiring part that is disposed between the inductor and a load.

### BRIEF DESCRIPTION OF DRAWINGS

FIG. 1 is a perspective view of a capacitor according to a first embodiment;

FIG. 2 is a top plan view of the capacitor;

FIG. 3 is a bottom plan view of the capacitor;

FIG. 4 is a sectional view of the capacitor, taken along Y1-Y1 line of FIG. 2;

FIG. 5 is a sectional view of the capacitor, taken along X1-X1 line of FIG. 2;

FIG. 6A is a simplified schematic drawing of the capacitor shown in FIG. 4;

FIG. 6B is a simplified schematic drawing of the capacitor shown in FIG. 5;

FIG. 7A is a sectional view of a main part of the capacitor;

FIG. 7B is a sectional view of another main part of the capacitor;

FIG. 8A is a circuit diagram of a power source module including the capacitor;

FIG. 8B is an equivalent circuit diagram, including a parasitic component, of the power source module including the capacitor;

FIG. 9 is a top plan view of the power source module including the capacitor;

FIG. 10 is a sectional view of the power source module including the capacitor;

FIGS. 11A and 11B are simplified sectional views of a capacitor according to a first variation of the first embodiment;

FIGS. 12A and 12B are simplified sectional views of a capacitor according to a second variation of the first embodiment;

FIGS. 13A and 13B are simplified sectional views of a capacitor according to a third variation of the first embodiment;

FIG. 14 is a simplified sectional view of a capacitor according to a fourth variation of the first embodiment;

FIG. 15 is a bottom view of a capacitor according to a fifth variation of the first embodiment;

FIG. 16 is a perspective view of a capacitor according to a second embodiment;

FIG. 17 is a plan view of the capacitor;

FIG. 18A is a sectional view of the capacitor, taken along X1-X1 line of FIG. 17;

FIG. 18B is a sectional view of the capacitor, taken along X2-X2 line of FIG. 17;

FIG. 19 is a sectional view of the capacitor, taken along Z1-Z1 line of FIG. 18A;

FIG. 20 is a sectional view of the capacitor, taken along Z2-Z2 line of FIG. 18A;

FIG. 21 is a circuit diagram of a power source module including the capacitor;

FIG. 22 is a sectional view of a power source module according to a first variation of the second embodiment;

FIG. 23 is a sectional view of a variation of the power source module including the capacitor;

FIG. 24 is a perspective view of a capacitor according to a second variation of the second embodiment;

FIG. 25 is a sectional view of the capacitor, taken along X1-X1 line of FIG. 24;

FIG. 26 is a perspective view of a capacitor according to another example of the second variation of the second embodiment;

FIG. 27 is a perspective view of a capacitor according to a third variation of the second embodiment;

FIG. 28 is a sectional view of the capacitor, taken along X2-X2 line of FIG. 27;

FIG. 29 is a plan view of a capacitor according to a fourth variation of the second embodiment;

FIG. 30 is a plan view of a capacitor according to a fifth variation of the second embodiment;

FIG. 31 is a plan view of a capacitor according to a sixth variation of the second embodiment;

FIG. 32 is a plan view of a capacitor according to a seventh variation of the second embodiment;

FIG. 33 is a circuit diagram of a power source module including the capacitor; and

FIG. 34 is a sectional view of an application example of the capacitor according to the first embodiment.

### DESCRIPTION OF EMBODIMENTS

The drawings to be referred to in the following description of embodiments are all schematic representations. Thus, the ratio of the dimensions (including thicknesses) of respective constituent elements illustrated on the drawings does not always reflect their actual dimensional ratio.

### First Embodiment

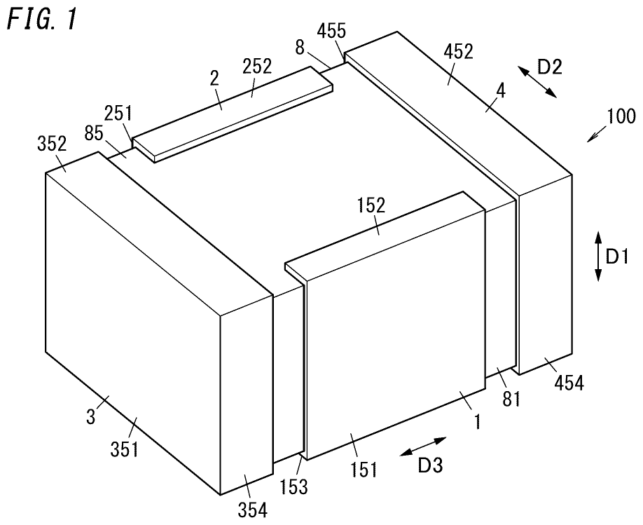

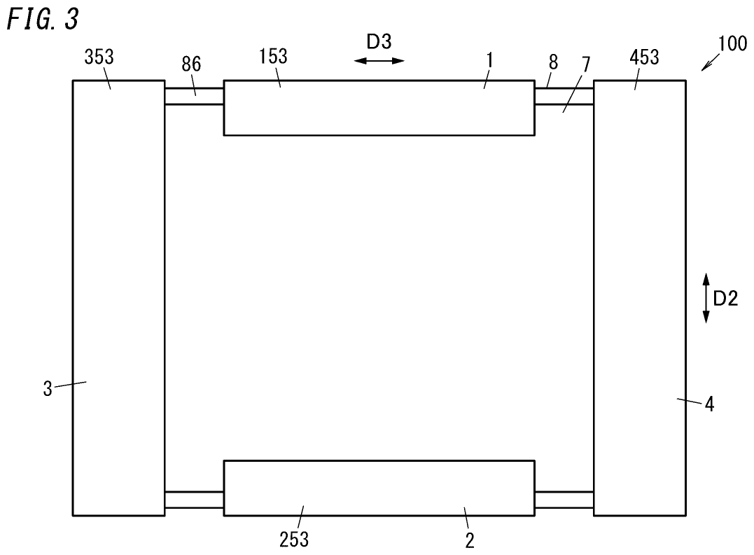

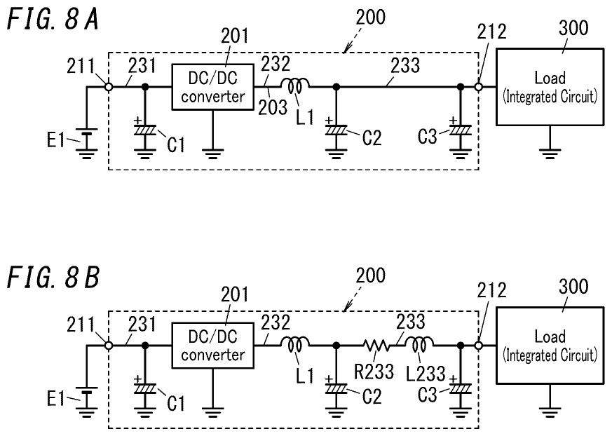

Hereinafter, a capacitor 100 according to a first embodiment will be described with reference to FIGS. 1 to 7B. After the description of the capacitor 100, a power source module 200 including the capacitor 100 will be described with reference to FIGS. 8A, 8B, 9 and 10.

### (1) Overview

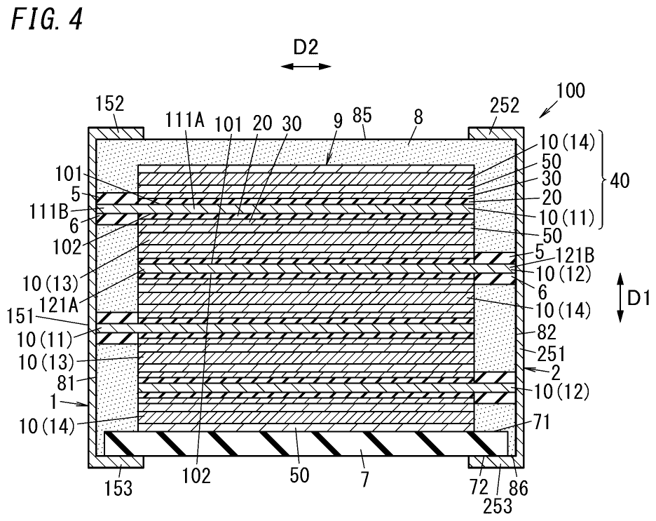

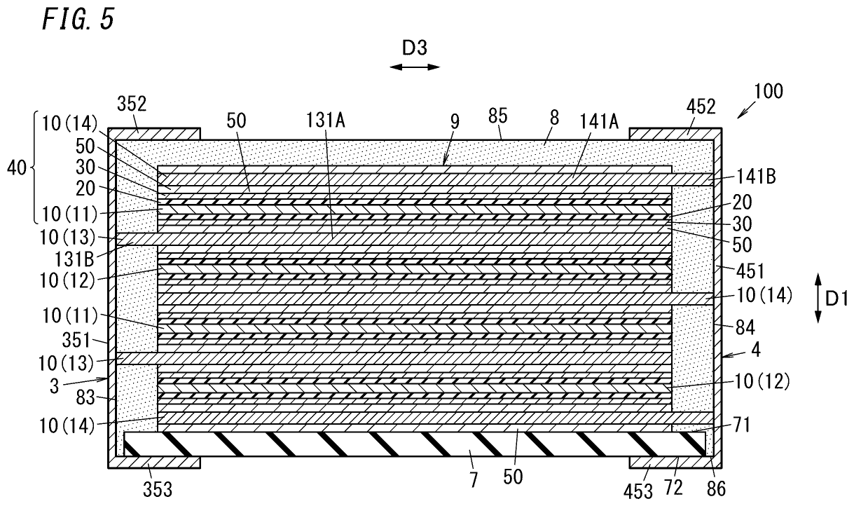

As shown in FIGS. 4 and 5, the capacitor 100 according to the first embodiment includes a layered body 9, a first external electrode 1, a second external electrode 2, a third external electrode 3 and a fourth external electrode 4. The layered body 9 includes a plurality of metal layers 10 and a plurality of dielectric layers 20. The plurality of metal layers 10 and the plurality of dielectric layers 20 are alternately arranged in a first direction D1. The first external electrode 1 and the second external electrode 2 are disposed to face each other with the layered body 9 being interposed between the first external electrode 1 and the second external electrode 2 in a second direction D2 orthogonal to the first direction D1. The third external electrode 3 and the fourth external electrode 4 are disposed to face each other with the layered body 9 being interposed between the third external electrode 3 and the fourth external electrode 4 in a third direction D3 orthogonal to both the first direction D1 and the second direction D2. The plurality of metal layers 10 include a plurality of first metal layers 11, a plurality of second metal layers 12, a plurality of third metal layers 13 and a plurality of fourth metal layers 14. The plurality of first metal layers 11 are connected to the first external electrode 1, and disposed away from the second external electrode 2. The plurality of first metal layers 11 are arranged apart from each other in the first direction D1. The plurality of first metal layers 11 are disposed away also from the third external electrode 3 and the fourth external electrode 4. The plurality of second metal layers 12 are connected to the second external electrode 2, and disposed away from the first external electrode 1. The plurality of second metal layers 12 are arranged apart from each other in the first direction D1. The plurality of second metal layers 12 are disposed away also from the third external electrode 3 and the fourth external electrode 4. The plurality of third metal layers 13 are connected to the third external electrode 3, and disposed away from the fourth external electrode 4. The plurality of third metal layers 13 are arranged apart from each other in the first direction D1. The plurality of third metal layers 13 are disposed away also from the first external electrode 1 and the second external electrode 2. The plurality of fourth metal layers 14 are connected to the fourth external electrode 4, and disposed away from the third external electrode 3. The plurality of fourth metal layers 14 are arranged apart from each other in the first direction D1. The plurality of fourth metal layers 14 are disposed away also from the first external electrode 1 and the second external electrode 2. In the plurality of metal layers 10, each of the plurality of first metal layers 11 is disposed in the first direction D1 adjacent to at least one metal layer 10 selected form a group consisting of the plurality of third metal layers 13 and the plurality of fourth metal layers 14. In the plurality of metal layers 10, each of the plurality of third metal layers 13 is disposed in the first direction D1 adjacent to at least one metal layer 10 selected form a group consisting of the plurality of first metal layers 11 and the plurality of second metal layers 12. “Each of the plurality of first metal layers 11 being disposed in the first direction D1 adjacent to at least one metal layer 10 selected form a group consisting of the plurality of third metal layers 13 and the plurality of fourth metal layers 14” means that a corresponding first metal layer 11 faces, in the first direction D1, at least one metal layer 10 selected form a group consisting of the plurality of third metal layers 13 and the plurality of fourth metal layers 14 while the other first metal layer 11 and any second metal layer 12 are not interposed between the corresponding first metal layer 11 and the at least one metal layer 10. Also, “each of the plurality of third metal layers 13 being disposed in the first direction D1 adjacent to at least one metal layer 10 selected form a group consisting of the plurality of first metal layers 11 and the plurality of second metal layers 12” means that a corresponding third metal layer 13 faces, in the first direction D1, at least one metal layer 10 selected form a group consisting of the plurality of first metal layers 11 and the plurality of second metal layers 12 while the other third metal layer 13 and any fourth metal layer 14 are not interposed between the corresponding third metal layer 13 and the at least one metal layer 10.

### (2) Details

Hereinafter, the capacitor 100 will be described, and after the description of the capacitor 100, the power source module 200 including the capacitor 100 will be described.

### (2.1) Capacitor

The configuration of the capacitor 100 according to the first embodiment will be described in detail with reference to FIGS. 1 to 7B.

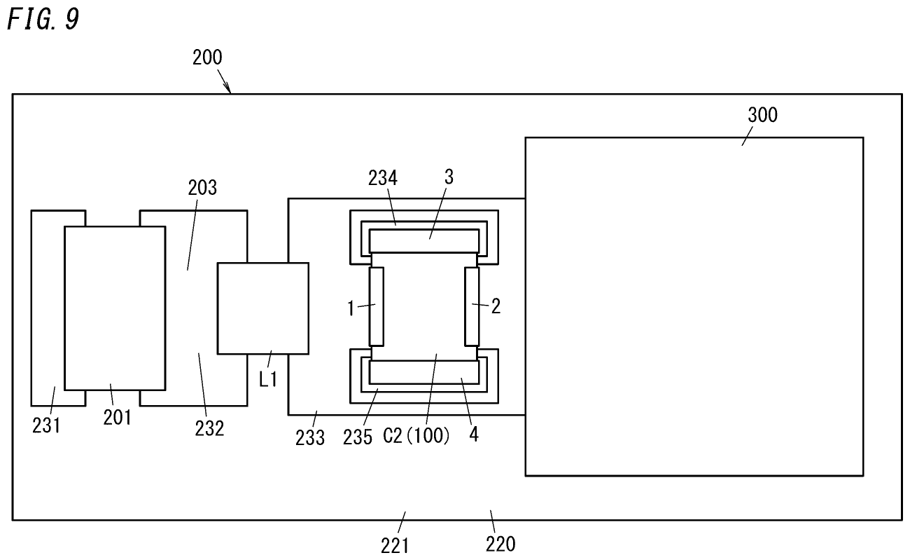

The capacitor 100 according to the first embodiment is an electrolytic capacitor. The capacitor 100 according to the first embodiment includes, as shown in FIGS. 1 to 3, a first external electrode 1, a second external electrode 2, a third external electrode 3, and a fourth external electrode 4, as a plurality of external connection electrodes for use to mount the capacitor 100 to a mounting board 220 (refer to FIG. 9) such as a motherboard. The first external electrode 1, the second external electrode, the third external electrode 3 and the fourth external electrode 4 are bonded to the mounting board 220 by soldering or any other manner. In the capacitor 100 according to the first embodiment, for example, the first external electrode 1, the second external electrode 2, the third external electrode 3, and the fourth external electrode 4 are used as a first anode, a second anode, a first cathode, and a second cathode, respectively. In this case, in the capacitor 100, the plurality of first metal layers 11 (refer to FIGS. 4 and 5) are connected to the first anode, the plurality of second metal layers 12 (refer to FIGS. 4 and 5) are connected to the second anode, the plurality of third metal layers 13 (refer to FIGS. 4 and 5) are connected to the first cathode, and the plurality of fourth metal layers 14 (refer to FIGS. 4 and 5) are connected to the second cathode. Alternatively, in the capacitor 100 according to the first embodiment, for example, the first external electrode 1, the second external electrode 2, the third external electrode 3, and the fourth external electrode 4 may be used as a first cathode, a second cathode, a first anode, and a second anode, respectively.

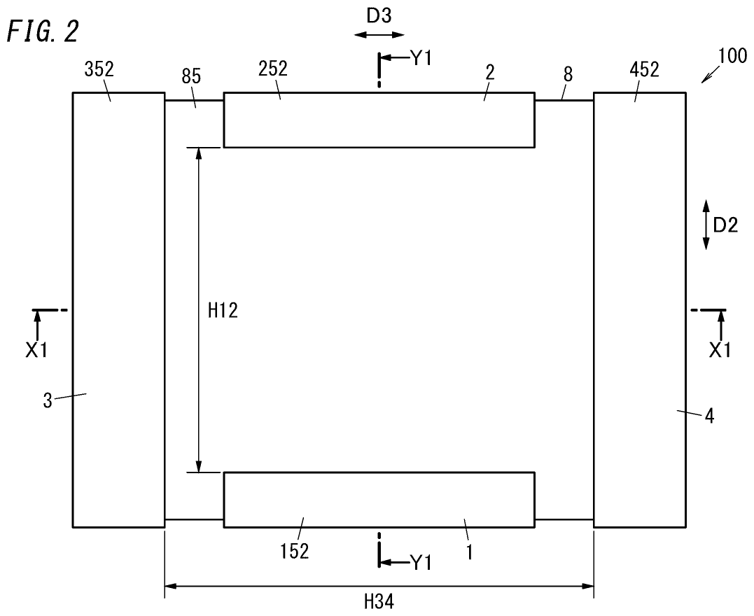

As shown in FIG. 4, the first external electrode 1 and the second external electrode 2 are disposed to face each other with the layered body 9 being interposed between the first external electrode 1 and the second external electrode 2 in a second direction D2 orthogonal to the first direction D1. As shown in FIG. 5, the third external electrode 3 and the fourth external electrode 4 are disposed to face each other with the layered body 9 being interposed between the third external electrode 3 and the fourth external electrode 4 in a third direction D3 orthogonal to both the first direction D1 and the second direction D2 (refer to FIGS. 1 and 4). In the capacitor 100, as shown in FIG. 2, a distance H12 between the first external electrode 1 and the second external electrode 2 in the second direction D2 is less than a distance H34 between the third external electrode 3 and the fourth external electrode 4 in the third direction D3.

As shown in FIGS. 4 and 5, the capacitor 100 further includes: a substrate 7 on which the layered body 9 is disposed; and an exterior 8 covering the layered body 9. The substrate 7 has a first main surface 71 and a second main surface 72 disposed opposite to the first main surface 71. In the capacitor 100, the layered body 9 is disposed on the first main surface 71 of the substrate 7.

The exterior 8 covers the layered body 9 and has a rectangular parallelepiped outer shape. The exterior 8 includes: a first main surface 81 and a second main surface 82 (refer to FIG. 4); a third main surface 83 and a fourth main surface 84 (refer to FIG. 5); and a fifth main surface 85 and a sixth main surface 86. The first main surface 81 and the second main surface 82 of the exterior 8 are disposed to be opposite to each other in the second direction D2 when viewed from the layered body 9. The third main surface 83 and the fourth main surface 84 of the exterior 8 are disposed to be opposite to each other in the third direction D3 when viewed from the layered body 9. The fifth main surface 85 and the sixth main surface 86 of the exterior 8 are disposed to be opposite to each other in the first direction D1 when viewed from the layered body 9.

As shown in FIG. 4, the first external electrode 1 is disposed over the first main surface 81, the fifth main surface 85 and the sixth main surface 86 of the exterior 8. The first external electrode 1 includes a first part 151 covering the first main surface 81 of the exterior 8, a second part 152 covering a part of the fifth main surface 85 of the exterior 8, and a third part 153 covering a part of the sixth main surface 86 of the exterior 8.

As shown in FIG. 4, the second external electrode 2 is disposed over the second main surface 82, the fifth main surface 85 and the sixth main surface 86 of the exterior 8. The second external electrode 2 includes a first part 251 covering the second main surface 82 of the exterior 8, a second part 252 covering a part of the fifth main surface 85 of the exterior 8, and a third part 253 covering a part of the sixth main surface 86 of the exterior 8.

As shown in FIG. 5, the third external electrode 3 is disposed over the third main surface 83, the fifth main surface 85 and the sixth main surface 86 of the exterior 8. The third external electrode 3 includes a first part 351 covering the third main surface 83 of the exterior 8, a second part 352 covering a part of the fifth main surface 85 of the exterior 8, and a third part 353 covering a part of the sixth main surface 86 of the exterior 8. As shown in FIG. 1, the third external electrode 3 further includes a fourth part 354 covering a part of the first main surface 81 of the exterior 8 and a fifth part covering a part of the second main surface 82 of the exterior 8.

As shown in FIG. 5, the fourth external electrode 4 is disposed over the fourth main surface 84, the fifth main surface 85, and the sixth main surface 86 of the exterior 8. The fourth external electrode 4 includes a first part 451 covering the fourth main surface 84 of the exterior 8, a second part 452 covering a part of the fifth main surface 85 of the exterior 8, and a third part 453 covering a part of the sixth main surface 86 of the exterior 8. As shown in FIG. 1, the fourth external electrode 4 further includes a fourth part 454 covering a part of the first main surface 81 of the exterior 8 and a fifth part 455 covering a part of the second main surface 82 of the exterior 8.

As shown in FIGS. 4 and 5, the layered body 9 has a plurality (e.g., nine) of metal layers 10 and a plurality (e.g., eight) of dielectric layers 20. In the layered body 9, the plurality of metal layers 10 and the plurality of dielectric layers 20 are alternately arranged in the first direction D1. In the plurality of metal layers 10, focusing on a plurality (e.g., two) of first metal layers 11 connected to the first external electrode 1 (e.g., the first anode) and a plurality (e.g., two) of second metal layers 12 connected to the second external electrode 2 (e.g., the second anode), the plurality (e.g., two) of first metal layers 11 and the plurality (e.g., two) of second metal layers 12 are arranged alternately on a layer-by-layer basis. Also, in the plurality of metal layers 10, focusing on a plurality (e.g., two) of third metal layers 13 connected to the third external electrode 3 (e.g., the first cathode) and a plurality (e.g., three) of fourth metal layers 14 connected to the fourth external electrode 4 (e.g., the second cathode), the plurality (e.g., two) of third metal layers 13 and the plurality (e.g., three) of fourth metal layers 14 are arranged alternately on a layer-by-layer basis. The plurality of first metal layers 11, the plurality of third metal layers 13, the plurality of second metal layers 12 and the plurality of fourth metal layers 14 are arranged in the first direction D1 repeatedly in an order of a first metal layer 11, a third metal layer 13, a second metal layer 12 and a fourth metal layer 14 on a layer-by-layer basis.

The layered body 9 includes a plurality of capacitor elements 40. Each of the plurality of capacitor elements 40 includes: two metal layers 10, adjacent to each other in the first direction D1, of the plurality of metal layers 10; and a single dielectric layer 20 positioned between the two metal layers 10. Each of the plurality of capacitor elements 40 further includes a solid electrolyte layer 30 interposed between the single dielectric layer 20 and one of the two metal layers 10. More specifically, each of the plurality of capacitor elements 40 includes: two metal layers 10 facing each other in a first direction D1; and a single dielectric layer 20 and a single solid electrolyte layer 30, which are positioned between the two metal layers 10. In this embodiment, each of the plurality of capacitor elements 40 further includes an adhesive layer 50 positioned between the solid electrolyte layer 30 and one metal layer 10, which is located opposite to the dielectric layer 20 when viewed from the solid electrolyte layer 30, of the two metal layers 10. The adhesive layer 50 is electrically conductive. Examples of material of the adhesive layer 50 include silver and carbon.

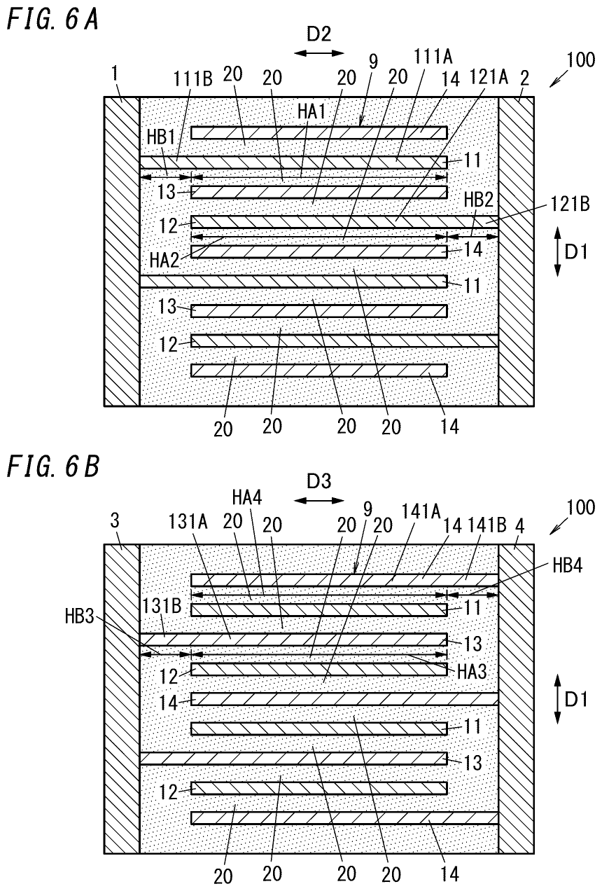

As shown in FIGS. 4 and 6A, each of the plurality of first metal layers 11 includes: a first part 111A overlapping the plurality of third metal layers 13 and the plurality of fourth metal layers 14 in the first direction D1; and a second part 111B not overlapping the plurality of third metal layers 13 and the plurality of fourth metal layers 14 in the first direction D1. Second parts 111B of the plurality of first metal layers 11 are connected to the first part 151 of the first external electrode 1. In each of the plurality of first metal layers 11, a length HB1 (refer to FIG. 6A) of the second part 111B in the second direction D2 is less than a length HA1 (refer to FIG. 6A) of the first part 111A in the second direction D2. In each of the plurality of first metal layers 11, the first part 111A is disposed to overlap the solid electrolyte layer 30 in a plane view from the first direction D1. In each of the plurality of first metal layers 11, the second part 111B is disposed not to overlap the solid electrolyte layer 30 in a plane view from the first direction D1. In FIG. 6A, the solid electrolyte layer 30 is not shown.

As shown in FIGS. 4 and 6A, each of the plurality of second metal layers 12 includes: a first part 121A overlapping the plurality of third metal layers 13 and the plurality of fourth metal layers 14 in the first direction D1; and a second part 121B not overlapping the plurality of third metal layers 13 and the plurality of fourth metal layers 14 in the first direction D1. Second parts 121B of the plurality of second metal layers 12 are connected to the first part 251 of the second external electrode 2. In each of the plurality of second metal layers 12, a length HB2 (refer to FIG. 6A) of the second part 121B in the second direction D2 is less than a length HA2 (refer to FIG. 6A) of the first part 121A in the second direction D2. In each of the plurality of second metal layers 12, the first part 121A is disposed to overlap the solid electrolyte layer 30 in a plane view from the first direction D1. In each of the plurality of second metal layers 12, the second part 121B is disposed not to overlap the solid electrolyte layer 30 in a plane view from the first direction D1.

As shown in FIGS. 5 and 6B, each of the plurality of third metal layers 13 includes: a first part 131A overlapping the plurality of first metal layers 11 and the plurality of second metal layers 12 in the first direction D1; and a second part 131B not overlapping the plurality of first metal layers 11 and the plurality of second metal layers 12 in the first direction D1. Second parts 131B of the plurality of third metal layers 13 are connected to the first part 351 of the third external electrode 3. In each of the plurality of third metal layers 13, a length HB3 (refer to FIG. 6B) of the second part 131B in the third direction D3 is less than a length HA3 (refer to FIG. 6B) of the first part 131A in the third direction D3. In each of the plurality of third metal layers 13, the first part 131A is disposed to overlap the solid electrolyte layer 30 in a plane view from the first direction D1. In each of the plurality of third metal layers 13, the second part 131B is disposed not to overlap the solid electrolyte layer 30 in a plane view from the first direction D1. In FIG. 6B, the solid electrolyte layer 30 is not shown.

As shown in FIGS. 5 and 6B, each of the plurality of fourth metal layers 14 includes: a first part 141A overlapping the plurality of first metal layers 11 and the plurality of second metal layers 12 in the first direction D1; and a second part 141B not overlapping the plurality of first metal layers 11 and the plurality of second metal layers 12 in the first direction D1. Second parts 141B of the plurality of fourth metal layers 14 are connected to the first part 451 of the fourth external electrode 4. In each of the plurality of fourth metal layers 14, a length HB4 (refer to FIG. 6B) of the second part 141B in the third direction D3 is less than a length HA4 (refer to FIG. 6B) of the first part 141A in the third direction D3. In each of the plurality of fourth metal layers 14, the first part 141A is disposed to overlap the solid electrolyte layer 30 in a plane view from the first direction D1. In each of the plurality of fourth metal layers 14, the second part 141B is disposed not to overlap the solid electrolyte layer 30 in a plane view from the first direction D1.

Each of the plurality of capacitor elements 40 has an anode layer serving as an anode therein. The anode layer includes a first part (i.e., the first part 111A or 121A) of one metal layer 10, which is located opposite to the solid electrolyte layer 30 when viewed from the dielectric layer 20, of the two metal layers 10. Each of the plurality of capacitor elements 40 further has a cathode layer serving as a cathode therein. The cathode layer includes: a first part (i.e., the first part 131A or 141A) of one metal layer 10, which is located opposite to the dielectric layer 20 when viewed from the solid electrolyte layer 30, of the two metal layers 10; the solid electrolyte layer 30; and the adhesive layer 50.

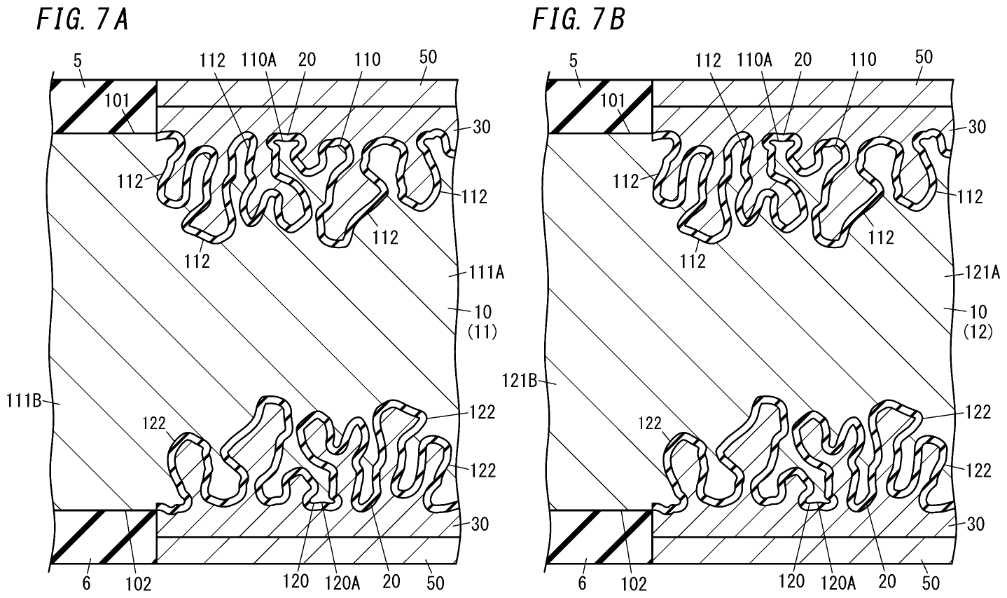

Examples of material of each of the plurality of metal layers 10 include a metal (e.g., aluminum). Each of the plurality of metal layers 10 is, for example, a metal foil (e.g., aluminum foil). The material of each of the plurality of metal layers 10 is not limited to aluminum. Alternatively, the material may be, for example, tantalum, niobium, titanium, or an alloy containing one or more types of metals selected from the group consisting of aluminum, tantalum, niobium and titanium. As shown in FIGS. 4, 7A and 7B, each of the plurality of metal layers 10 has a first main surface 101 and a second main surface 102 disposed opposite to the first main surface 101. As shown in FIGS. 7A and 7B, each of the plurality of metal layers 10 includes a first porous part 110 and a second porous part 120, for example. The first porous part 110 includes a plurality of holes 112 provided in the first main surface 101 of the metal layer 10. The second porous part 120 includes a plurality of holes 122 provided in the second main surface 102 of the metal layer 10. The first porous part 110 and the second porous part 120 are formed by etching (e.g., electrolytic etching) a surface of a metal foil from which the metal layer 10 is based.

Examples of material of each of the plurality of dielectric layers 20 include aluminum oxide. Each of the plurality of dielectric layers 20 is layered on a first main surface 101 or a second main surface 102 of any one metal layer 10 of the plurality of first metal layers 11 and the plurality of second metal layers 12. A dielectric layer 20, layered on the first main surface 101 of the metal layer 10, of the plurality of dielectric layers 20 is provided along the surface 110A of the first porous part 110, thereby having a shape along the surface 110A of the first porous part 110. A dielectric layer 20, layered on the second main surface 102 of the metal layer 10, of the plurality of dielectric layers 20 is provided along the surface 120A of the second porous part 120, thereby having a shape along the surface 120A of the second porous part 120. The plurality of dielectric layers 20 are formed, for example, by anodizing or the like. In FIGS. 4 and 5, the first porous part 110 and the second porous part 120 in the metal layer 10 are not shown, and each of the first main surface 101 and the second main surface 102 of the metal layer 10 is shown in a planar shape.

As shown in FIGS. 4 and 5, each of the solid electrolyte layers 30 is disposed on a corresponding dielectric layer 20. As shown in FIGS. 7A and 7B, the solid electrolyte layer 30, layered on the dielectric layer 20 on the first main surface 101 of the metal layer 10, includes: a plurality of columnar parts positioned within the plurality of holes 112 in the first porous part 110 of the metal layer 10; and a part to which ends of the plurality of columnar parts are connected. The solid electrolyte layer 30, layered on the dielectric layer 20 on the second main surface 102 of the metal layer 10, includes: a plurality of columnar parts positioned within the plurality of holes 122 in the second porous part 120 of the metal layer 10; and a part to which ends of the plurality of columnar parts are connected.

The solid electrolyte layer 30 includes, for example, conductive polymers. Examples of the conductive polymers may include polypyrrole, polythiophene, polyaniline, and derivatives thereof. The solid electrolyte layer 30 may be formed, for example, by applying a solution in which conductive polymers are dissolved or a dispersion in which conductive polymers are dispersed, to the dielectric layer 20. Alternatively, the solid electrolyte layer 30 may be formed by carrying out chemical polymerization and/or electrolytic polymerization of raw material monomers on the dielectric layer 20. The solid electrolyte layer 30 may include a manganese compound.

The capacitor 100 further includes a first insulating film 5 and a second insulating film 6, which cover a second part (i.e., second part 111B or 121B) partially having a first main surface 101 and a second main surface 102 of a metal layer 10 corresponding to any one of the plurality of first metal layers 11 and the plurality of second metal layers 12, out of the plurality of metal layers 10. With respect to each of the plurality of first metal layers 11, the first insulating film 5 covers the second part 111B partially having the first main surface 101 of the metal layer 10 corresponding to the first metal layer 11, as shown in FIGS. 4 and 7A. With respect to each of the plurality of first metal layers 11, the second insulating film 6 covers the second part 111B partially having the second main surface 102 of the metal layer 10 corresponding to the first metal layer 11. With respect to each of the plurality of second metal layers 12, the first insulating film 5 covers the second part 121B partially having the first main surface 101 of the metal layer 10 corresponding to the second metal layer 12, as shown in FIGS. 4 and 7B. With respect to each of the plurality of second metal layers 12, the second insulating film 6 covers the second part 121B partially having the second main surface 102 of the metal layer 10 corresponding to the second metal layer 12. Each of the first insulating film 5 and the second insulating film 6 has electric insulation. Examples of material of each of the first insulating film 5 and the second insulating film 6 include a resin. Examples of the resin include an insulating resin such as epoxy resin, phenolic resin, silicone resin, melamine resin, urea resin, alkyd resin, polyurethane, polyamide, polyimide, polyamideimide, or unsaturated polyester. Each of the first insulating films 5 and the second insulating films 6 may be formed, for example, by a method such as screen printing, ink jet, transfer, or tape-pasting. Each of the first insulating film 5 and the second insulating film 6 may include not only the resin but also a filler.

As shown in FIGS. 4 and 5, the layered body 9 is supported by the substrate 7 described above. In this embodiment, the layered body 9 is fixed to the first main surface 71 of the substrate 7 by an adhesive layer 50 closest to the substrate 7, out of a plurality of adhesive layers 50 included in the layered body 9.

The substrate 7 is, for example, an insulating substrate. The substrate 7 is not limited to an insulating substrate. For example, if the first external electrode 1 and the second external electrode 2 are electrically insulated from the third external electrode 3, the substrate 7 may not be electrically insulated from the fourth external electrode 4. Alternatively, the substrate 7 may be, for example, a multilayer substrate or a printed wiring board.

The exterior 8 preferably includes, for example, a cured product of a curable resin composition. The exterior 8 may include a thermoplastic resin or a composition including the same.

The exterior 8 may be formed by a molding technique, such as injection molding. The curable resin composition may include not only a curable resin but also a filler, a curing agent, a polymerization initiators, and/or a catalyst. Examples of the curable resin include epoxy resin, phenolic resin, urea resin, polyimide, polyamide imide, polyurethane, diallyl phthalate, unsaturated polyester, and the like. Examples of the thermoplastic resin include polyphenylene sulfide (PPS), polybutylene terephthalate (PBT), and the like. Alternatively, as the material of the exterior 8, a thermoplastic resin composition including a thermoplastic resin and a filler may be used.

As the filler, for example, insulating particles and/or fibers are preferred. Examples of the insulating material constituting the filler include an insulating compound (oxide, etc.) such as silica or alumina, glass, and a mineral material (talc, mica, clay, etc.). The exterior 8 may include one of those fillers, or two or more of those fillers.

The resin used for the exterior 8 may include the same resin as that used for the first insulating film 5 and the second insulating film 6 described above, which can improve the adhesion of the exterior 8 with respect to the first insulating film 5 and the second insulating film 6. Examples of the same resin included in the first insulating film 5, the second insulating film 6, and the exterior 8 include epoxy resin. The filler that may be included in the exterior 8 may be different from the filler that may be included in the first and second insulating films 5 and 6.

The first external electrode 1, the second external electrode 2, the third external electrode 3, and the fourth external electrode 4 are metal electrodes. The material of each of the metal electrodes includes at least one selected from the group consisting of, for example, nickel (Ni), copper (Cu), zinc (Zn), tin (Sn), silver (Ag), gold (Au), and palladium (Pd).

Each of the first external electrode 1, the second external electrode 2, the third external electrode 3, and the fourth external electrode 4 may have a single-layer structure. However, this is only an example and should not be construed as limiting. Alternatively, each of those external electrodes 1 to 4 may have a multi-layer structure. If having the multi-layer structure, each of the first external electrode 1, the second external electrode 2, the third external electrode 3, and the fourth external electrode 4 includes, for example, a first metal film (e.g., a Ni film) disposed on the exterior 8 and connected to the metal layer 10, and a second metal film (e.g., a Sn film) disposed on the first metal film. The material of the second metal film is not limited to Sn, and may be, for example, Au, Ag or Pd. If having the single-layer structure, the material of each of the first external electrode 1, the second external electrode 2, the third external electrode 3, and the fourth external electrode 4 is preferably, in terms of solder wettability, for example, Sn, Au, Ag, or Pd. In the capacitor 100, the first external electrode 1 is directly connected to the plurality of first metal layers 11, but this is only an example and should not be construed as limiting. Alternatively, a first contact layer having electrical conductivity may be interposed between the first external electrode 1 and each of the plurality of first metal layers 11. In capacitor 100, the second external electrode 2 is directly connected to the plurality of second metal layers 12, but this is only an example and should not be construed as limiting. Alternatively, a second contact layer having electrical conductivity may be interposed between the second external electrode 2 and each of the plurality of second metal layers 12. In the capacitor 100, the third external electrode 3 is directly connected to the plurality of third metal layers 13, but this is only an example and should not be construed as limiting. Alternatively, a third contact layer having electrical conductivity may be interposed between the third external electrode 3 and each of the plurality of third metal layers 13. In the capacitor 100, the fourth external electrode 4 is directly connected to the plurality of fourth metal layers 14, but this is only an example and should not be construed as limiting. Alternatively, a fourth contact layer having electrical conductivity may be interposed between the fourth external electrode 4 and each of the plurality of fourth metal layers 14. The first external electrode 1, the second external electrode 2, the third external electrode 3, and the fourth external electrode 4 may be formed by, for example, an electroless plating method, an electrolytic plating method, a physical vapor deposition method, a chemical vapor deposition method, a cold spraying method, or a thermal spraying method.

### (2.2) Power Source Module

Hereinafter, the power source module 200 will be described with reference to FIGS. 8A, 8B, 9 and 10.

### (2.2.1) Circuit Configuration of Power Source Module

As shown in FIG. 8A, the power source module 200 includes a DC/DC converter 201, an inductor L1, and a plurality of capacitors C1, C2, and C3. Hereinafter, the capacitors C1, C2 and C3 are sometimes referred to as a “first capacitor C1,” a “second capacitor C2,” and a “third capacitor C3,” respectively. In the power source module 200, each of the second capacitor C2 and the third capacitor C3 is constituted by a capacitor 100.

The power source module 200 includes an input end 211 and an output end 212. To the input end 211, a DC power supply E1 is connected. To the output end 212, a load 300 is connected. The load 300 is not a component of the power source module 200 in this embodiment, but this is only an example and should not be construed as limiting. Alternatively, the load 300 may be a component of the power source module 200. The load 300 includes, for example, an integrated circuit. The integrated circuit is, for example, a processor provided in a computer system or microcontroller, and more particularly, a Central Processing Unit (CPU), a Graphics Processing Unit (GPU), or a Field-Programmable Gate Array (FPGA). The integrated circuit is called by a different name depending on the degree of integration thereof, and includes an integrated circuit referred to as a system LSI, a Very Large Scale Integration (VLSI), or an Ultra Large Scale Integration (ULSI). Optionally, a FPGA to be programmed after an LSI has been fabricated or a reconfigurable logic device allowing the connections or circuit sections inside of an LSI to be reconfigured may also be adopted as the processor. Alternatively, the load 300 may be an Application Specific Integrated Circuit (ASIC).

The DC/DC converter 201 converts a first DC voltage output from the DC power supply E1 into a second DC voltage and outputs the second DC voltage thus converted. The DC/DC converter 201 is a switching type converter. The DC/DC converter 201 includes a switching element, and the switching element is operated at a switching frequency which is for example, equal to or more 200 kHz but equal to or less than 10 MHz. The DC power supply E1 is not a component of the power source module 200 in this embodiment, but this is only an example and should not be construed as limiting. Alternatively, the DC power supply E1 may be a component of the power source module 200. The DC power supply E1 has a positive electrode and a negative electrode. The DC power supply E1 is, for example, a battery. In the power source module 200, the positive electrode of the DC power supply E1 is connected to the input end 211 of the power source module 200. The power source module 200 further includes a wiring part 231 (hereinafter, also referred to as a “first wiring part 231”) connecting the input end 211 of the power source module 200 and an input end of the DC/DC converter 201.

The inductor L1 is provided on a current path 203 from the DC/DC converter 201 to the load 300. The current path 203 includes: a wiring part 232 (hereinafter, also referred to as a “second wiring part 232”) connecting the DC/DC converter 201 and the inductor L1; and a wiring part 233 (hereinafter, also referred to as a “third wiring part 233”) connecting the inductor L1 and the output end 212 of the power source module 200. The power source module 200 includes a low pass filter. The low pass filter includes the inductor L1 and the second capacitor C2.

The first capacitor C1 is connected between the ground and the first wiring part 231 that is disposed between the input end 211 of the power source module 200 and the DC/DC converter 201. The first capacitor C1 is, for example, an electrolytic capacitor.

The second capacitor C2 is connected between the third wiring part 233 and the ground. The second capacitor C2 is an electrolytic capacitor constituted by the capacitor 100 described above.

The third capacitor C3 is connected between the third wiring part 233 and the ground. A connection point between the third capacitor C3 and the third wiring part 233 is located between: a connection point between the second capacitor C2 and the third wiring part 233; and the output end 212 of the power source module 200. The third capacitor C3 is an electrolytic capacitor constituted by the capacitor 100 described above.

In the power source module 200, the third capacitor C3, out of the first capacitor C1, second capacitor C2, and third capacitor C3, is a capacitor that is electrically closest to the load 300. The second capacitor C2, out of those capacitors C1-C3, is a capacitor that is electrically second closest to the load 300. In other words, in the power source module 200, the wiring length between the third capacitor C3 and the output end 212 of the power source module 200 is shorter than the wiring length between the second capacitor C2 and the output end 212 of the power source module 200. Thus, in the power source module 200, the wiring length between the third capacitor C3 and the load 300 is shorter than the wiring length between the second capacitor C2 and the load 300. Also, in the power source module 200, the wiring length between the third capacitor C3 and the load 300 is shorter than the wiring length between the DC/DC converter 201 and the load 300. Thus, in the power source module 200, the wiring impedance between the third capacitor C3 and the load 300 is less than the wiring impedance between the DC/DC converter 201 and the load 300.

FIG. 8B is an equivalent circuit diagram including parasitic elements, of the power source module 200. In FIG. 8B, a parasitic resistor R233 and a parasitic inductor L233 of the third wiring part 233 are shown. The wiring impedance of the third wiring part 233 is determined depending on the resistance value of the parasitic resistor R233 and the inductance of the parasitic inductor L233.

### (2.2.2) Structure of Power Source Module

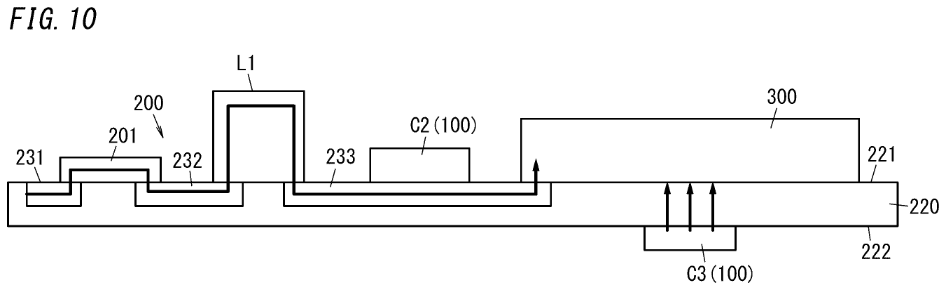

The power source module 200 includes the DC/DC converter 201, the inductor L1, the first capacitor C1 (refer to FIGS. 8A and 8B), the second capacitor C2, the third capacitor C3, and a mounting board 220, as shown in FIGS. 9 and 10. The mounting board 220 is, for example, a printed wiring board. The mounting board 220 constitutes a motherboard. Each of the first capacitor C1, the second capacitor C2, and the third capacitor C3 is an electrolytic capacitor. FIG. 10 illustrates paths of currents flowing in the power source module 200 schematically by arrows.

The mounting board 220 has a first main surface 221 and a second main surface 222 opposite to the first main surface 221. The mounting board 220 includes a plurality of conductors. The plurality of conductors include the first wiring part 231, the second wiring part 232, the third wiring part 233, a ground conductor 234, and a ground conductor 235. The ground conductors 234 and 235 are conductors to which ground potential is given. The potentials of the first wiring part 231, the second wiring part 232, and the third wiring part 233 are different from the ground potential and, for example, higher than the ground potential.

In the capacitor 100 constituting the second capacitor C2, the first external electrode 1 and the second external electrode 2 are connected to the third wiring part 233. Also, in the capacitor 100 constituting the second capacitor C2, the third external electrode 3 is connected to the ground conductor 234, and the fourth external electrode 4 is connected to the ground conductor 235.

In the power source module 200, for example, the load 300 including an integrated circuit is electrically connected to the third wiring part 233. The load 300 is, for example, an IC component including: an IC chip including an integrated circuit; and a surface mount package covering the IC chip. The surface mount package is, for example, a Ball Grid Array (BGA) and has a plurality of metal balls as a plurality of external terminals. The plurality of external terminals include: an external power terminal corresponding to a power terminal of the integrated circuit; and an external ground terminal corresponding to a ground terminal of the integrated circuit. In the mounting board 220, the external power terminal of the load 300 is connected to the third wiring part 233. The plurality of conductors further includes a ground conductor to which the external ground terminal of the load 300 is connected.

### (3) Recapitulation

### (3.1) Capacitor

The capacitor 100 according to the first embodiment includes the layered body 9, the first external electrode 1, the second external electrode 2, the third external electrode 3 and the fourth external electrode 4. The layered body 9 includes the plurality of metal layers 10 and the plurality of dielectric layers 20. The plurality of metal layers 10 and the plurality of dielectric layers 20 are alternately arranged in the first direction D1. The first external electrode 1 and the second external electrode 2 are disposed to face each other with the layered body 9 being interposed between the first external electrode 1 and the second external electrode 2 in the second direction D2 orthogonal to the first direction D1. The third external electrode 3 and the fourth external electrode 4 are disposed to face each other with the layered body 9 being interposed between the third external electrode 3 and the fourth external electrode 4 in the third direction D3 orthogonal to both the first direction D1 and the second direction D2. The plurality of metal layers 10 include the plurality of first metal layers 11, the plurality of second metal layers 12, the plurality of third metal layers 13 and the plurality of fourth metal layers 14. The plurality of first metal layers 11 are connected to the first external electrode 1, and disposed away from the second external electrode 2. The plurality of first metal layers 11 are arranged apart from each other in the first direction D1. The plurality of second metal layers 12 are connected to the second external electrode 2, and disposed away from the first external electrode 1. The plurality of second metal layers 12 are arranged apart from each other in the first direction D1. The plurality of third metal layers 13 are connected to the third external electrode 3, and disposed away from the fourth external electrode 4. The plurality of third metal layers 13 are arranged apart from each other in the first direction D1. The plurality of fourth metal layers 14 are connected to the fourth external electrode 4, and disposed away from the third external electrode 3. The plurality of fourth metal layers 14 are arranged apart from each other in the first direction D1. In the plurality of metal layers 10, each of the plurality of first metal layers 11 is disposed in the first direction D1 adjacent to at least one metal layer 10 selected form the group consisting of the plurality of third metal layers 13 and the plurality of fourth metal layers 14. In the plurality of metal layers 10, each of the plurality of third metal layers 13 is disposed in the first direction D1 adjacent to at least one metal layer 10 selected form the group consisting of the plurality of first metal layers 11 and the plurality of second metal layers 12.

The capacitor 100 according to the first embodiment can contribute to achieving a lower impedance thereof. More specifically, in the capacitor 100 according to the first embodiment, the first external electrode 1 (to which the plurality of first metal layers 11 are connected) and the second external electrode 2 (to which the plurality of second metal layers 12 are connected) face each other in the second direction D2, and the plurality of first metal layers 11 and the plurality of second metal layers 12 are arranged in the first direction D1. Accordingly, in the capacitor 100 according to the first embodiment, the orientation of the current flowing through the second part 111B of each of the plurality of first metal layers 11 is reversed from the orientation of the current flowing through the second part 121B of each of the plurality of second metal layers 12. Therefore, in the capacitor 100 according to the first embodiment, the magnetic field generated by the current flowing through the first metal layer 11 and the magnetic field generated by the current flowing through the second metal layer 12 cancel each other, which allows reducing the magnetic flux generated in each of the capacitor elements 40 including the first metal layer 11 and the capacitor element 40 including the second metal layer 12. Thus, the capacitor 100 according to the first embodiment can reduce Equivalent Series Induction (ESL). In addition, in the capacitor 100 according to the first embodiment, the third external electrode 3 (to which the plurality of third metal layers 13 are connected) and the fourth external electrode 4 (to which the plurality of fourth metal layers 14 are connected) face each other in the third direction D3, and the plurality of third metal layers 13 and the plurality of fourth metal layers 14 are arranged in the first direction D1. Accordingly, in the capacitor 100 according to the first embodiment, the orientation of the current flowing through the second part 131B of each of the plurality of third metal layers 13 is reversed from the orientation of the current flowing through the second part 141B of each of the plurality of fourth metal layers 14. Therefore, in the capacitor 100 according to the first embodiment, the magnetic field generated by the current flowing through the third metal layer 13 and the magnetic field generated by the current flowing through the fourth metal layer 14 cancel each other, which allows reducing the magnetic flux generated in each of the capacitor elements 40 including the third metal layer 13 and the capacitor element 40 including the fourth metal layer 14. Thus, the capacitor 100 according to the first embodiment can further reduce the ESL. As a result, the capacitor 100 according to the first embodiment can contribute to achieving a lower impedance thereof, and in particular, can reduce the impedance over a wider frequency band.

### (3.2) Power Source Module

The power source module 200 according to the first embodiment includes the DC/DC converter 201, the inductor L1 connected to the output end of the DC/DC converter 201, and the capacitor 100 (i.e., the capacitor C3) connected between the ground and the wiring part 233 that is disposed between the inductor L1 and the load 300. According to this configuration, the power source module 200 according to the first embodiment can contribute to achieving a lower impedance of the capacitor 100.

In the power source module 200, the voltage supplied to the load 300 varies due to the switching operation for the switching element of the DC/DC converter 201 and the variation in the current flowing from the power source module 200 to the load 300. However, in the power source module 200 according to the first embodiment, since the capacitor C3 is constituted by the capacitor 100, even when the current flowing from the power source module 200 to the load 300 suddenly varies, it is possible to suppress the variation in the voltage supplied from the power source module 200 to the load 300 (the power supply voltage input to the integrated circuit of the load 300). The power source module 200 also includes the capacitor 100 which can achieve a lower impedance over a wider frequency band, thereby allowing a smaller number of capacitors required to control the variation range of the voltages supplied to the load 300 to fall within a predetermined range.

### (4) Variation of First Embodiment

### (4.1) First Variation

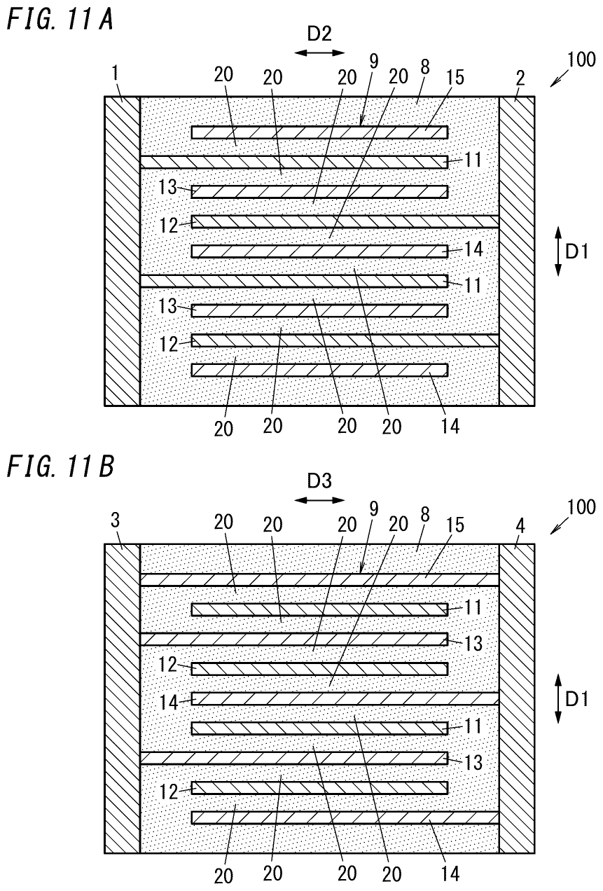

As shown in FIGS. 11A and 11B, a capacitor 100 according to a first variation differs from the capacitor 100 according to the first embodiment in that a plurality of metal layers 10 further includes a fifth metal layer 15. With regard to the capacitor 100 according to the first variation, elements similar to those of the capacitor 100 according to the first embodiment are assigned with same reference signs, and the explanations thereof are appropriately omitted. FIGS. 11A and 11B are simplified views for explaining the order of the plurality of metal layers 10, similarly to FIGS. 6A and 6B.

The fifth metal layer 15 is located at one end of a layered body 9 in a first direction D1. The fifth metal layer 15 is connected to both a third external electrode 3 and a fourth external electrode 4, and disposed away from a first external electrode 1 and a second external electrode 2, as shown in FIG. 11B.

In the capacitor 100 according to the first variation, the fifth metal layer 15 functions as a shielding layer by connecting the third external electrode 3 and the fourth external electrode 4 to the ground. Accordingly, the capacitor 100 according to the first variation is less affected by foreign noise, compared with the capacitor 100 according to the first embodiment.

The capacitor 100 according to the first variation is not limited to being an electrolytic capacitor including a solid electrolyte layer 30 and an exterior 8, but may be, for example, a multi-layer ceramic capacitor (MLCC). In case that the capacitor 100 is an MLCC, material for a dot-hatched portion of each of FIGS. 11A and 11B includes ceramic.

### (4.2) Second Variation

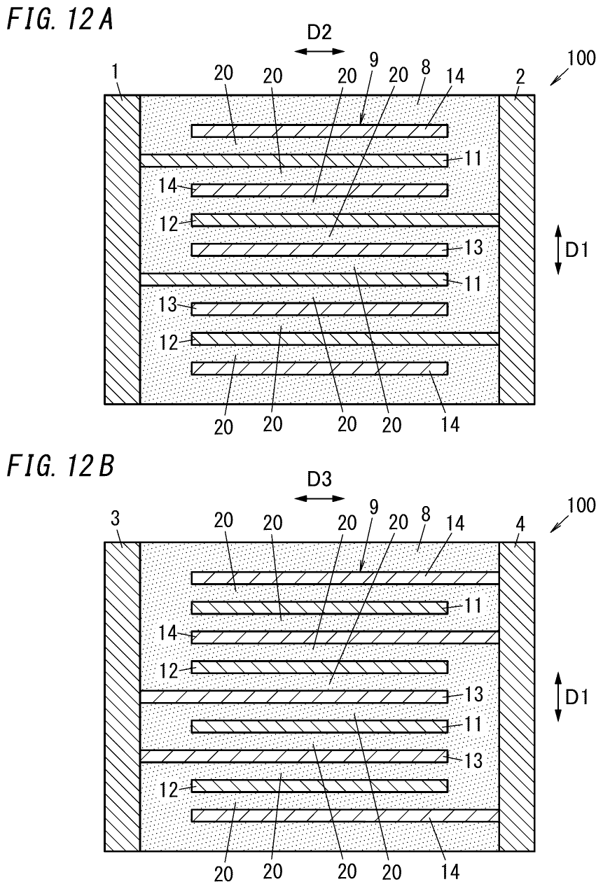

As shown in FIGS. 12A and 12B, a capacitor 100 according to a second variation differs from the capacitor 100 according to the first embodiment in that a plurality (e.g., two) of third metal layers 13 and a plurality (e.g., three) of fourth metal layers 14 are not arranged alternately on a layer-by-layer basis in a first direction D1. With regard to the capacitor 100 according to the second variation, elements similar to those of the capacitor 100 according to the first embodiment are assigned with same reference signs, and the explanations thereof are appropriately omitted. FIGS. 12A and 12B are simplified views for explaining the order of the plurality of metal layers 10.

In the capacitor 100 according to the second variation, two third metal layers 13 and three fourth metal layers 14 are arranged in the first direction D1 in the order of a fourth metal layer 14, a fourth metal layer 14, a third metal layer 13, a third metal layer 13, and a fourth metal layers 14.

In the capacitor 100 according to the second variation, a plurality (nine in the illustrated example) of metal layers 10 are arranged in the first direction D1 in the order of a fourth metal layer 14, a first metal layer 11, a fourth metal layer 14, a second metal layer 12, a third metal layer 13, a first metal layer 11, a third metal layer 13, a second metal layer 12, and a fourth metal layer 14.

The capacitor 100 according to the second variation is not limited to being an electrolyte capacitor including a solid electrolyte layer 30 (refer to FIGS. 4 and 5) and an exterior 8, but may be, for example, an MLCC. In case that the capacitor 100 is an MLCC, material for a dot-hatched portion of each of FIGS. 12A and 12B includes ceramic. The entire dot-hatched portion of each of FIGS. 12A and 12B is included in the layered body 9.

### (4.3) Third Variation

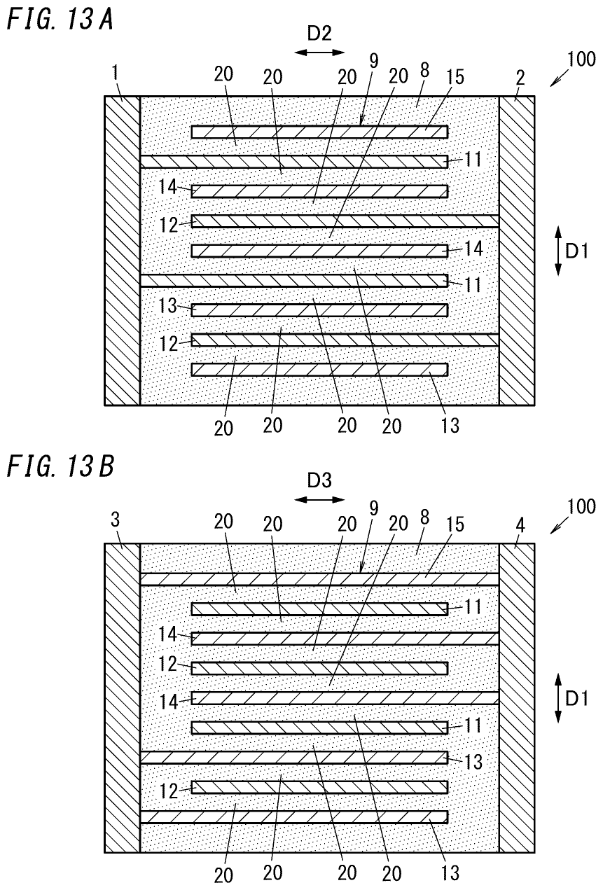

As shown in FIGS. 13A and 13B, a capacitor 100 according to a third variation differs from the capacitor 100 according to the first embodiment in that a plurality of metal layers 10 further includes a fifth metal layer 15. Furthermore, the capacitor 100 according to the third variation differs from the capacitor 100 according to the first embodiment in that a plurality (e.g., two) of third metal layers 13 and a plurality (e.g., two) of fourth metal layers 14 are not arranged alternately on a layer-by-layer basis in a first direction D1. With regard to the capacitor 100 according to the third variation, elements similar to those of the capacitor 100 according to the first embodiment are assigned with same reference signs, and the explanations thereof are appropriately omitted. FIGS. 13A and 13B are simplified views for explaining the order of the plurality of metal layers 10.

The fifth metal layer 15 is located at one end of a layered body 9 in the first direction D1. The fifth metal layer 15 is connected to both a third external electrode 3 and a fourth external electrode 4, and disposed away from a first external electrode 1 and a second external electrode 2, as shown in FIG. 13B.

In the capacitor 100 according to the third variation, two third metal layers 13 and two fourth metal layers 14 are arranged in the first direction D1 in the order of a fourth metal layer 14, a fourth metal layer 14, a third metal layer 13, and a third metal layer 13.

In the capacitor 100 according to the third variation, a plurality (nine in the illustrated example) of metal layers 10 are arranged in the first direction D1 in the order of a fifth metal layer 15, a first metal layer 11, a fourth metal layer 14, a second metal layer 12, a fourth metal layer 14, a first metal layer 11, a third metal layer 13, a second metal layer 12, and a third metal layer 13.

In the capacitor 100 according to the third variation, the fifth metal layer 15 functions as a shielding layer by connecting the third external electrode 3 and the fourth external electrode 4 to the ground. Accordingly, the capacitor 100 according to the third variation is less affected by foreign noise, compared with the capacitor 100 according to the first embodiment.

The capacitor 100 according to the third variation is not limited to being an electrolytic capacitor, but may be, for example, an MLCC. In case that the capacitor 100 is an MLCC, material for a dot-hatched portion of each of FIGS. 13A and 13B includes ceramic. The entire dot-hatched portion of each of FIGS. 13A and 13B is included in the layered body 9.

### (4.4) Fourth Variation

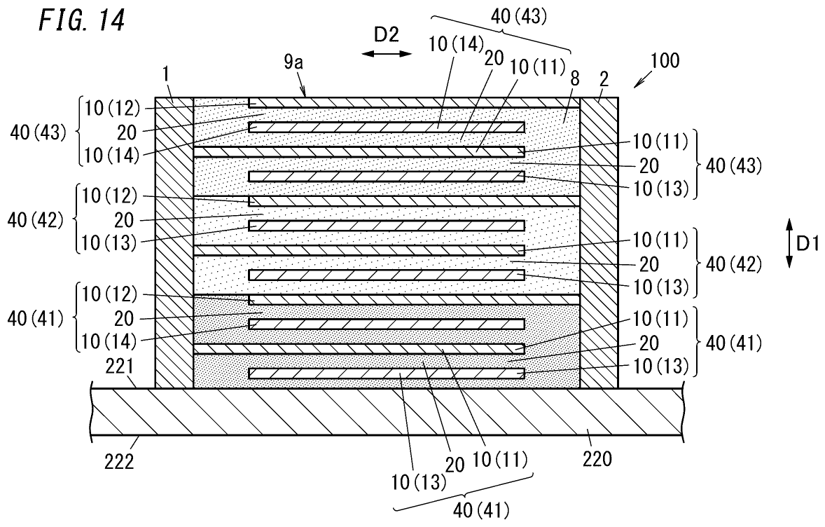

Hereinafter, a capacitor 100 according to a fourth variation will be described with reference to FIG. 14.

The capacitor 100 according to the fourth variation differs from the capacitor 100 according to the first embodiment in that a layered body 9a is included instead of the layered body 9 of the capacitor 100 according to the first embodiment. With regard to the capacitor 100 according to the fourth variation, elements similar to those of the capacitor 100 according to the first embodiment are assigned with same reference signs, and the explanations thereof are appropriately omitted. FIG. 14 is a simplified view for explaining the order of a plurality of capacitor elements 40. In FIG. 14, a mounting board 220 on which the capacitor 100 is mounted is shown, but the mounting board 220 is not a component of the capacitor 100.

The layered body 9a includes a plurality of capacitor elements 40, similarly to the layered body 9 of the capacitor 100 according to the first embodiment. Each of the plurality of capacitor elements 40 includes: two metal layers 10, adjacent to each other in a first direction D1, out of a plurality of metal layers 10; and a single dielectric layer 20, positioned between the two metal layers 10, out of a plurality of dielectric layers 20.

In the layered body 9a, the plurality of capacitor elements 40 includes a first capacitor element 41, a second capacitor element 42, and a third capacitor element 43. The first capacitor element 41, the second capacitor element 42, and the third capacitor element 43 are arranged in the first direction D1 in the order of the first capacitor element 41, the second capacitor element 42, and the third capacitor element 43.

In the capacitor 100 according to the fourth variation, the impedance of the first capacitor element 41, the impedance of the second capacitor element 42, and the impedance of the third capacitor element 43 are different from one another. In the capacitor 100 of the fourth variation, the capacitance of the second capacitor element 42 is greater than the capacitance of the first capacitor element 41, and the capacitance of the third capacitor element 43 is greater than the capacitance of the second capacitor element 42. For example, the capacitances of the first capacitor element 41, the second capacitor element 42 and the third capacitor element 43 are 100 μF, 200 μF and 400 μF, respectively. These values are merely examples, and the capacitances of the capacitor elements are not limited to them.

Furthermore, in the capacitor 100 according to the fourth variation, the resonant frequency of the first capacitor element 41 is greater than the resonant frequency of the second capacitor element 42, and the resonant frequency of the second capacitor element 42 is greater than the resonant frequency of the third capacitor element 43. The resonant frequencies of the capacitor elements 40 are determined depending on the capacitances and the ESLs of the capacitor elements 40.

The first capacitor element 41, the second capacitor element 42, and the third capacitor element 43 have mutually different capacitances, depending on that those capacitor elements 41-43 differ from one another in at least one selected from the group consisting of factors: an area where one of the two metal layers 10 faces the other of the two metal layers 10 in the first direction D1; a distance between the two metal layers 10 in the first direction D1; a dielectric constant of the single dielectric layer 20.

The capacitor 100 is disposed on the mounting board 220 such that the first capacitor element 41, the second capacitor element 42, and the third capacitor element 43 are arranged in the order of the first capacitor element 41, the second capacitor element 42, and the third capacitor element 43 from a side close to the mounting board 220, as shown in FIG. 14, for example. This allows the capacitor 100 to achieve a lower impedance at a higher frequency.

The capacitor 100 according to the fourth variation can achieve a lower impedance over a wider frequency band, compared to the capacitor 100 according to the first embodiment.

In the capacitor 100 according to the fourth variation, the plurality of capacitor elements 40 may include, for example, a fourth capacitor element with a capacitance different from any of the capacitances of the first capacitor element 41, the second capacitor element 42, and the third capacitor element 43. In the capacitor 100 according to the fourth variation, the plurality of capacitor elements 40 are needed to include at least the first capacitor element 41 and the second capacitor element 42. In this variation, in the plurality of capacitor elements 40, as long as a capacitor element having a relatively larger capacitance is located farther from the mounting board 220 in the first direction D1 than a capacitor element having a relatively smaller capacitance, two capacitor elements having the same capacitance value may be arranged in the first direction D1. For example, a first capacitor element 41, a first capacitor element 41, a second capacitor element 42, and a second capacitor element 42 may be arranged in the first direction D1 in the order of the first capacitor element 41, first capacitor element 41, second capacitor element 42, and second capacitor element 42 from a side close to the mounting board 220.

The capacitor 100 according to the fourth variation is not limited to being an electrolytic capacitor, but may be, for example, an MLCC. In case that the capacitor 100 is an MLCC, material for a dot-hatched portion in FIG. 14 includes ceramic. The entire dot-hatched portion in FIG. 14 is included in the layered body 9a.

### (4.5) Fifth Variation

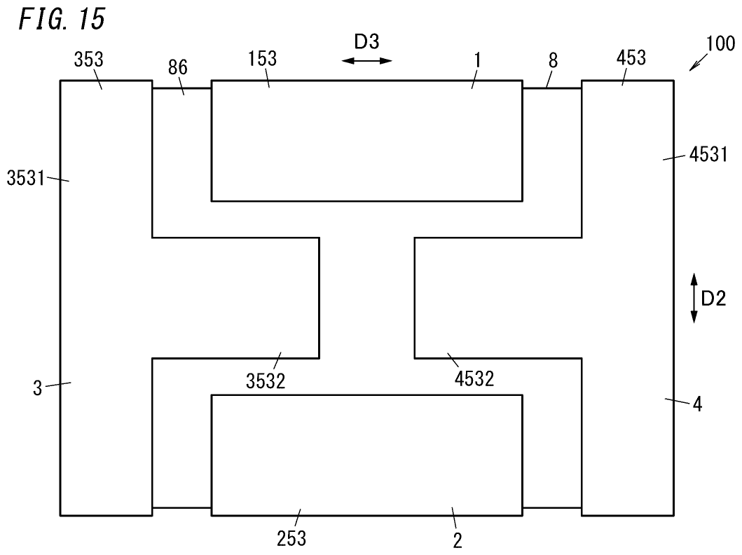

As shown in FIG. 15, a capacitor 100 according to a fifth variation differs from the capacitor 100 according to the first embodiment in that a third part 353 of a third external electrode 3, which is disposed on a sixth main surface 86 of an exterior 8, has a T-shape, and furthermore a third part 453 of a fourth external electrode 4, which is disposed on the sixth main surface 86 of the exterior 8, also has a T-shape. With regard to the capacitor 100 according to the fifth variation, elements similar to those of the capacitor 100 according to the first embodiment are assigned with same reference signs, and the explanations thereof are appropriately omitted.

The third part 353 of the third external electrode 3 includes: a main part 3531 elongated in a second direction D2 and rectangularly shaped; and a protrusion 3532 projecting from the main part 3531 toward the fourth external electrode 4 in a third direction D3.

The third part 453 of the fourth external electrode 4 includes: a main part 4531 elongated in the second direction D2 and rectangularly shaped; and a protrusion 4532 projecting from the main part 4531 toward the fourth external electrode 4 in the third direction D3.

Compared with the capacitor 100 according to the first embodiment, the capacitor 100 according to the fifth variation can have a larger area in a plane view of the third part 353 of the third external electrode 3 and a larger area in a plane view of the third part 453 of the fourth external electrode 4. Accordingly, the capacitor 100 according to the fifth variation can reduce a resistance value of a junction between the third external electrode 3 and a ground conductor 234 of a mounting board 220 (refer to FIGS. 9 and 10); and a resistance value of a junction between the fourth external electrode 4 and a ground conductor 235 of the mounting board 220. Examples of material of each junction include solder.

### Second Embodiment

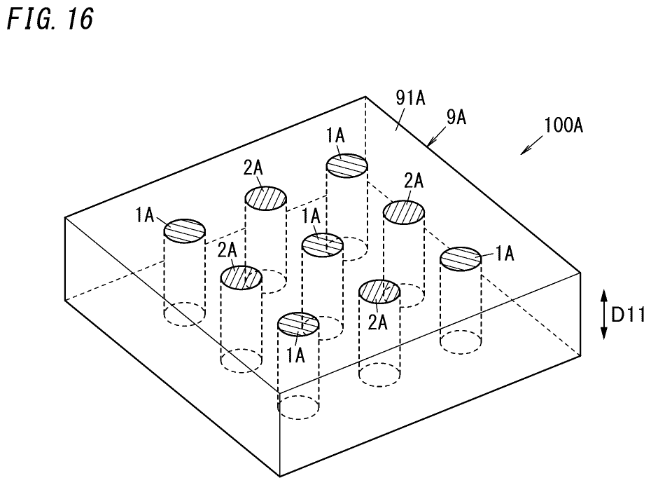

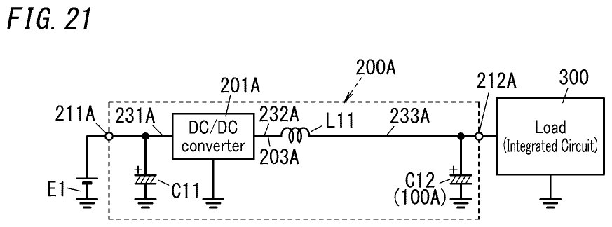

Hereinafter, a capacitor 100A according to a second embodiment will be described with reference to FIGS. 16, 17, 18A, 18B, 19 and 20. After the description of the capacitor 100A, a power source module 200A including the capacitor 100A will be described with reference to FIG. 21.

### (1) Overview

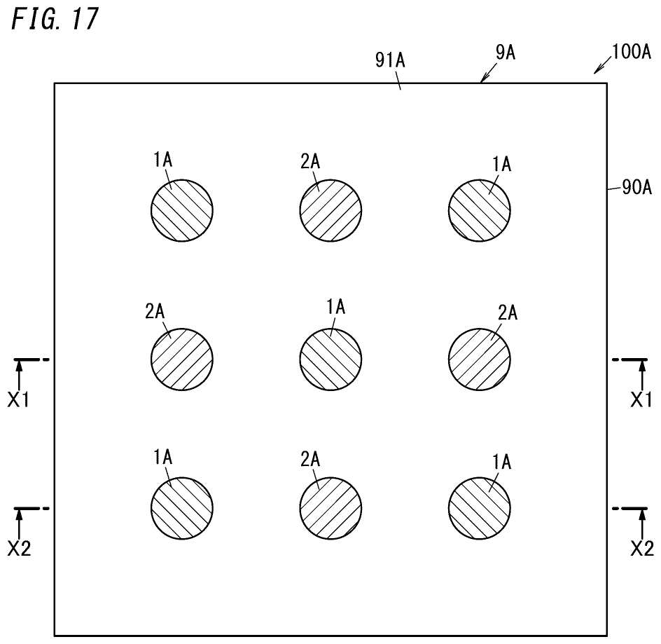

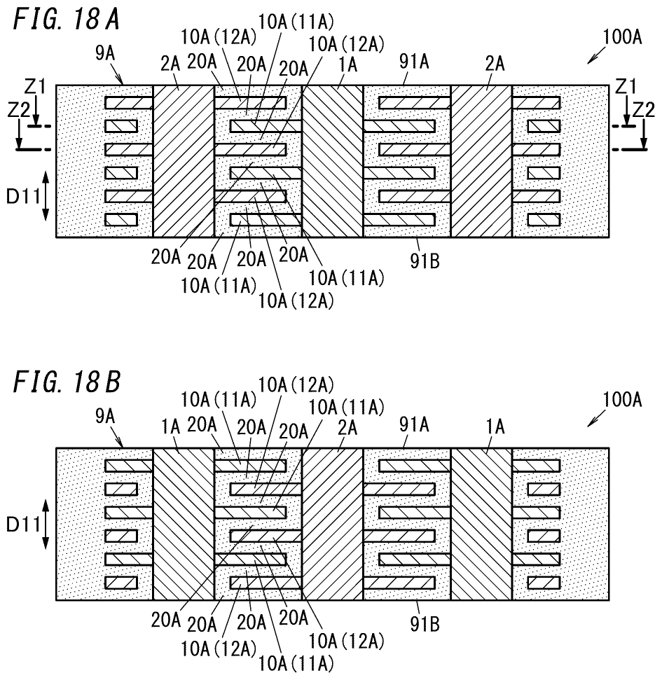

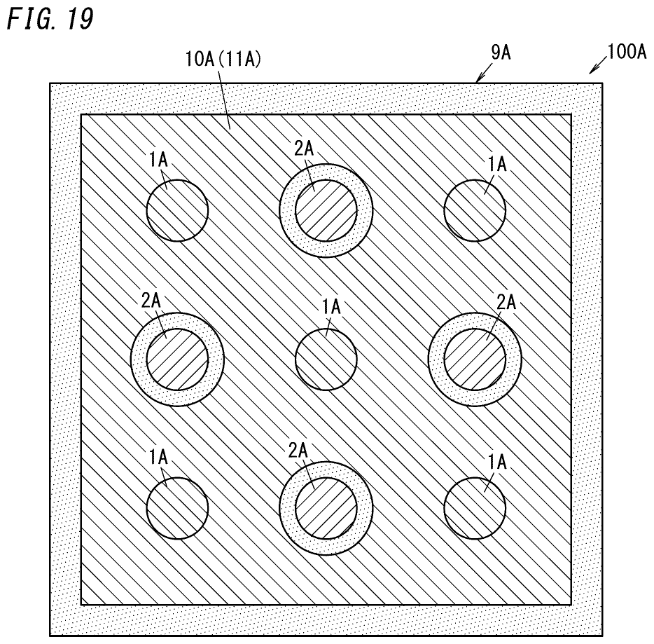

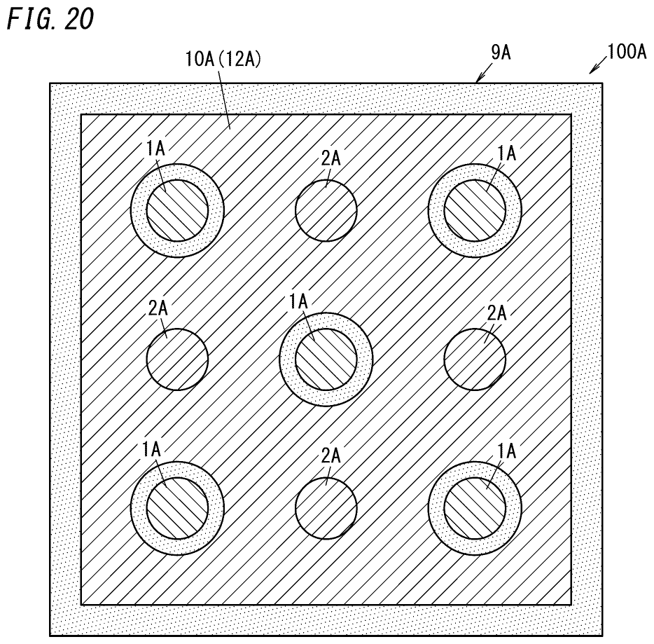

The capacitor 100A according to the second embodiment includes a layered body 9A, a plurality of first external electrodes 1A and a plurality of second external electrodes 2A. As shown in FIGS. 18A and 18B, the layered body 9A includes a plurality of metal layers 10A and a plurality of dielectric layers 20A. The plurality of metal layers 10A and the plurality of dielectric layers 20A are alternately arranged in a thickness direction D11 of the layered body 9A. All of the plurality of first external electrodes 1A and the plurality of second external electrodes 2A are disposed to penetrate the layered body 9A in the thickness direction D11 of the layered body 9A. The plurality of metal layers 10A includes a plurality of first metal layers 11A and a plurality of second metal layers 12A. The plurality of first metal layers 11A are connected to the plurality of first external electrodes 1A, and disposed away from the plurality of second external electrodes 2A. The plurality of first metal layers 11A are arranged apart from each other in the thickness direction D11 of the layered body 9A. The plurality of second metal layers 12A are connected to the plurality of second external electrodes 2A, and disposed away from the plurality of first external electrodes 1A. The plurality of second metal layers 12A are arranged apart from each other in the thickness direction D11 of the layered body 9A. In the plurality of metal layers 10A, the plurality of first metal layers 11A and the plurality of second metal layers 12A are arranged alternately on a layer-by-layer basis in the thickness direction D11 of the layered body 9A. FIGS. 16 and 17 are not cross-sectional views, but each of the first external electrode 1A and the second external electrode 2 is shown by the same hatching as hatching of the cross-sectional view (refer to FIGS. 18A, 18B, 19, and 20) in order to distinguish the first external electrode 1A from the second external electrode 2A. Furthermore, in the capacitor 100A according to the second embodiment, the plurality of first external electrodes 1A are connected to each other via a first metal layer 11A (refer to FIG. 19). The plurality of second external electrodes 2A are connected to each other via a second metal layer 12A (refer to FIG. 20).

### (2) Details

Hereinafter, the capacitor 100A will be described, and after the description of the capacitor 100A, the power source module 200A including the capacitor 100A will be described.

### (2.1) Capacitor

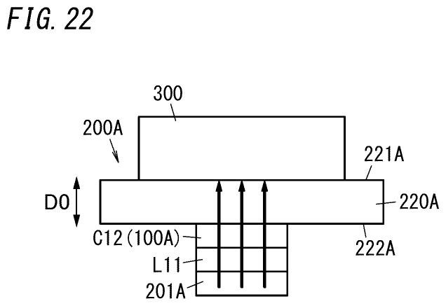

The capacitor 100A according to the second embodiment includes a plurality (nine in the illustrated example) of external electrodes for use to mount to a mounting board 220A (refer to FIG. 22), such as a motherboard. The plurality of external electrodes includes a plurality (five in the illustrated example) of first external electrodes 1A and a plurality (four in the illustrated example) of second external electrodes 2A, as shown in FIGS. 16 and 17. The plurality of first external electrodes 1A and the plurality of second external electrodes 2A are bonded to the mounting board 220A by soldering or any other manner. In the capacitor 100A according to the second embodiment, for example, the plurality of first external electrodes 1A are used as anodes and the plurality of second external electrodes 2A are used as cathodes. In this case, in the capacitor 100A, the plurality of first metal layers 11A are connected to the anodes and the plurality of second metal layers 12A are connected to the cathode. Alternatively, in the capacitor 100A according to the second embodiment, for example, the plurality of first external electrodes 1A may be used as cathodes and the plurality of second external electrodes 2A may be used as anodes.

As shown in FIGS. 18A and 18B, the layered body 9A includes: a first main face 91A intersecting a thickness direction D11 of the layered body 9A; and a second main face 91B opposite to the first main face 91A. The layered body 9A has an outer edge 90A (refer to FIGS. 17) with a rectangular or square shape (square shape in the illustrated example) in a plane view from the thickness direction D11 of the layered body 9A.

As shown in FIGS. 18A and 18B, the layered body 9A has a plurality (e.g., six) of metal layers 10A and a plurality (e.g., seven) of dielectric layers 20A. In the layered body 9A, the plurality of metal layers 10A and the plurality of dielectric layers 20A are alternately arranged in thickness direction D11 of the layered body 9A. In the plurality of metal layers 10A, a plurality (e.g., three) of first metal layers 11A and a plurality (e.g., three) of second metal layers 12A are arranged alternately on a layer-by-layer basis.

Examples of material of each of the plurality of metal layers 10A include a metal (e.g., aluminum). Each of the plurality of metal layers 10A is, for example, a metal foil (e.g., aluminum foil). The material of each of the plurality of metal layers 10A is not limited to aluminum. Alternatively, the material may be, for example, tantalum, niobium, titanium, or an alloy containing one or more types of metals selected from the group consisting of aluminum, tantalum, niobium and titanium.

Examples of material of each of the plurality of dielectric layers 20A includes a resin and a ceramic.

Each of the plurality of first external electrodes 1A and the plurality of second external electrodes 2A is a metal electrode (a through via conductor). Each of the plurality of first external electrodes 1A and the plurality of second external electrodes 2A has a cylindrical shape. Each of the plurality of first external electrodes 1A and the plurality of second external electrodes 2A has, for example, a circular shape in a plane view from the thickness direction D11 of the layered body 9A. The plurality of first external electrodes 1A and the plurality of second external electrodes 2A have the same diameter. Herein “same” is not limited to strictly the same case, but the diameters thereof may fall within a range of equal to or more than 90% but equal to or less than 110% with respect to a diameter of a first external electrode 1A disposed at the center. The material of each of the metal electrodes includes at least one type of metal selected from the group consisting of, for example, nickel (Ni), copper (Cu), zinc (Zn), tin (Sn), silver (Ag), and gold (Au).

The plurality of external electrodes (including the plurality of first external electrodes 1A and the plurality of second external electrodes 2A) are arranged in a two-dimensional array. In other words, the plurality of external electrodes are arranged in a matrix of m×n (m=3, n=3). The plurality of external electrodes are disposed away from each other in a plane view from the thickness direction D11 of the layered body 9A. In the capacitor 100A, five first external electrodes 1A are respectively positioned at the center and four corners of the layered body 9A in a plane view from the thickness direction D11 of the layered body 9A, and each of four second external electrodes 2A is positioned between two corresponding first external electrodes 1A adjacent to each other in a direction along the outer edge 90A of the layered body 9A.

### (2.2) Power Source Module

Hereinafter, the power source module 200A will be described with respect to FIGS. 21 and 22.

### (2.2.1) Circuit Configuration of Power Source Module

The power source module 200A includes a DC/DC converter 201A, an inductor L11, and a plurality of capacitors C11, C12, as shown in FIG. 21. Hereinafter, the capacitors C11 and C12 may be referred to as a “first capacitor C11” and a “second capacitor C12,” respectively. In the power source module 200A, the second capacitor C12 is constituted by the capacitor 100A.

The power source module 200A includes an input end 211A and an output end 212A. To the input end 211A, a DC power supply E1 is connected. To the output end 212A, a load 300 is connected. The load 300 is not a component of the power source module 200A in this embodiment, but this is only an example and should not be construed as limiting. Alternatively, the load 300 may be a component of the power source module 200A. The load 300 includes, for example, an integrated circuit. The integrated circuit is, for example, a processor provided in a computer system or microcontroller, and more particularly, a Central Processing Unit (CPU), a Graphics Processing Unit (GPU), or a Field-Programmable Gate Array (FPGA). The integrated circuit is called by a different name depending on the degree of integration thereof, and includes an integrated circuit referred to as a system LSI, a Very Large Scale Integration (VLSI), or an Ultra Large Scale Integration (ULSI). Optionally, a FPGA to be programmed after an LSI has been fabricated or a reconfigurable logic device allowing the connections or circuit sections inside of an LSI to be reconfigured may also be adopted as the processor. Alternatively, the load 300 may be an Application Specific Integrated Circuit (ASIC).

The DC/DC converter 201A converts a first DC voltage output from the DC power supply E1 into a second DC voltage, and outputs the second DC voltage thus converted. The DC/DC converter 201A is a switching type converter. The DC/DC converter 201A includes a switching element, and the switching element is operated at a switching frequency which is for example, equal to or more 200 kHz but equal to or less than 10 MHz. The DC power supply E1 is not a component of the power source module 200A in this embodiment, but this is only an example and should not be construed as limiting. Alternatively, the DC power supply E1 may be a component of the power source module 200A. The DC power supply E1 has a positive electrode and a negative electrode. The DC power supply E1 is, for example, a battery. In the power source module 200A, the positive electrode of the DC power supply E1 is connected to the input end 211A of the power source module 200A. The power source module 200A further includes a wiring part 231A (hereinafter, also referred to as a “first wiring part 231A”) connecting the input end 211A of the power source module 200A and an input end of the DC/DC converter 201A.

The inductor L11 is provided on a current path 203A from the DC/DC converter 201A to the load 300. The current path 203A includes: a wiring part 232A (hereinafter, also referred to as a “second wiring part 232A”) connecting the DC/DC converter 201A and the inductor L11; and a wiring part 233A (hereinafter, also referred to as a “third wiring part 233A”) connecting the inductor L11 and the output end 212A of the power source module 200A. The power source module 200A includes a low pass filter. The low pass filter includes the inductor L11 and the second capacitor C12.

The first capacitor C11 is connected between the ground and the first wiring part 231A that is disposed between the input end 211A of the power source module 200A and the DC/DC converter 201A. The first capacitor C11 is, for example, an electrolytic capacitor.

The second capacitor C12 is connected between the third wiring part 233A and the ground. The second capacitor C12 is an electrolytic capacitor constituted by the capacitor 100A described above. Note that, the second capacitor C12 has both a function as the second capacitor C2 and a function as the third capacitor C3 in the power source module 200 (refer to FIGS. 18A and 18B) according to the first embodiment.

### (2.2.2) Structure of Power Source Module

The power source module 200A includes the DC/DC converter 201A, the inductor L11, the first capacitor C11 (refer to FIG. 21), the second capacitor C12, and a mounting board 220A, as shown in FIG. 22. The mounting board 220A is, for example, a printed wiring board. The mounting board 220A constitutes a motherboard. Each of the first capacitor C11 and the second capacitor C12 is an electrolytic capacitor. FIG. 22 illustrates paths of currents flowing in the power source module 200A schematically by arrows. In FIG. 22, the first capacitor C11 is not shown.

The mounting board 220A has a first main surface 221A and a second main surface 222A opposite to the first main surface 221A.

The second capacitor C12 is constituted by the capacitor 100A described above.

The load 300 is, for example, an IC component including: an IC chip including an integrated circuit; and a surface mount package covering the IC chip. The surface mount package is, for example, a Ball Grid Array (BGA) and has a plurality of metal balls as a plurality of external terminals. The plurality of external terminals include: an external power terminal corresponding to a power terminal of the integrated circuit; and an external ground terminal corresponding to a ground terminal of the integrated circuit. The plurality of external terminals of the load 300 are bonded to the mounting board 220A.

In the power source module 200A, the capacitor 100A is disposed on the second main surface 222A of the mounting board 220A. The load 300 is disposed on the first main surface 221A of the mounting board 220A. In the power source module 200A, the load 300 and the capacitor 100A overlap each other in a plane view from a thickness direction D0 of the mounting board 220A. The mounting board 220A includes a plurality of through wiring parts connecting the capacitor 100A and the load 300. In the power source module 200A, on the second main surface 222A side of the mounting board 220A, the inductor L11 is stacked on the capacitor 100A and the DC/DC converter 201A is stacked on the inductor L11.

The power source module 200A can realize a vertical power supplying from the capacitor 100A along the thickness direction D0 of the mounting board 220A. Therefore, the power source module 200A can further suppress the variation in the power supply voltage input to the load 300.

### (3) Recapitulation

### (3.1) Capacitor

The capacitor 100A according to the second embodiment includes the layered body 9A, the plurality of first external electrodes 1A and the plurality of second external electrodes 2A. The layered body 9A includes the plurality of metal layers 10A and the plurality of dielectric layers 20A. The plurality of metal layers 10A and the plurality of dielectric layers 20A are alternately arranged in the thickness direction D11 of the layered body 9A. All of the plurality of first external electrodes 1A and the plurality of second external electrodes 2A are disposed to penetrate the layered body 9A in the thickness direction D11 of the layered body 9A. The plurality of metal layers 10A includes the plurality of first metal layers 11A and the plurality of second metal layers 12A. The plurality of first metal layers 11A are connected to the plurality of first external electrodes 1A, and disposed away from the plurality of second external electrodes 2A. The plurality of first metal layers 11A are arranged apart from each other in the thickness direction D11 of the layered body 9A. The plurality of second metal layers 12A are connected to the plurality of second external electrodes 2A, and disposed away from the plurality of first external electrodes 1A. The plurality of second metal layers 12A are arranged apart from each other in the thickness direction D11 of the layered body 9A. In the plurality of metal layers 10A, the plurality of first metal layers 11A and the plurality of second metal layers 12A are arranged alternately on a layer-by-layer basis in the thickness direction D11 of the layered body 9A.

The capacitor 100A according to the second embodiment can contribute to achieving a lower impedance thereof.

### (3.2) Power Source Module

The power source module 200A according to the second embodiment includes the DC/DC converter 201A, the inductor L11 and the capacitor 100A. The inductor L11 is connected to the output end of the DC/DC converter 201A. The capacitor 100A is connected between the ground and the wiring part 233A that is disposed between the inductor L11 and the load 300.

The power source module 200A according to the second embodiment can contribute to achieving a lower impedance of the capacitor 100A.

### (4) Variation of Second Embodiment

### (4.1) First Variation

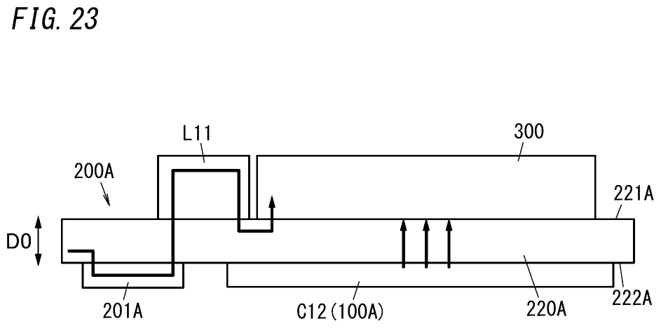

In a power source module 200A according to a first variation of the second embodiment, as shown in FIG. 23, a DC/DC converter 201A and a second capacitor C12 are disposed adjacent to each other on a second main surface 222A of a mounting board 220A, and a first inductor L11 is disposed on a first main surface 221A of the mounting board 220A. The inductor L11 overlaps a part of the DC/DC converter 201A and a part of the second capacitor C12 in a plane view from a thickness direction D0 of the mounting board 220A. FIG. 23 illustrates paths of currents flowing in the power source module 200A schematically by arrows. In FIG. 23, the first capacitor C11 (refer to FIG. 21) is not shown.

A load 300 is disposed on the first main surface 221A of the mounting board 220A. In the power source module 200A, the load 300 and a capacitor 100A overlap each other in a plane view from the thickness direction D0 of the mounting board 220A. The mounting board 220A includes a plurality of through wiring parts connecting the capacitor 100A and the load 300.

### (4.2) Second Variation

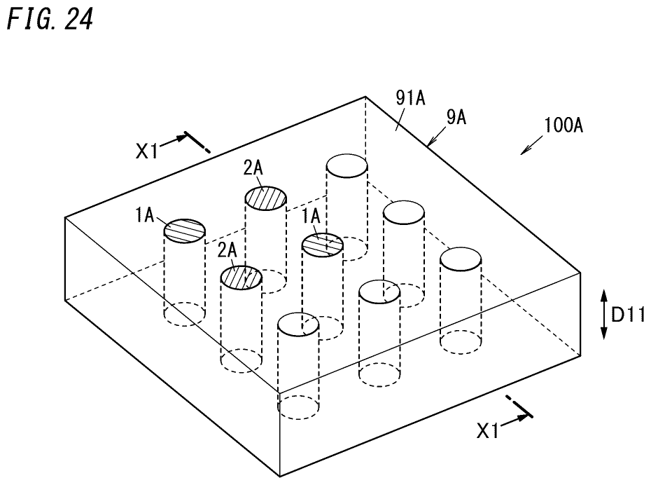

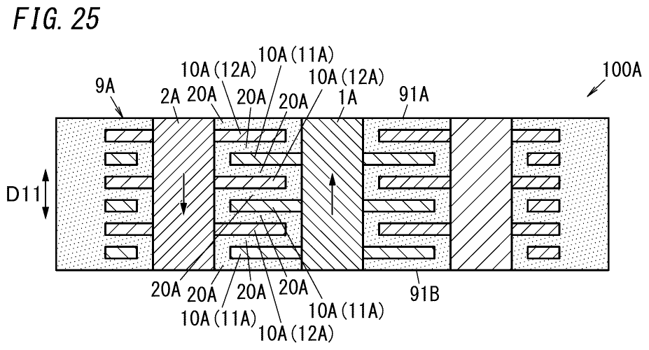

A capacitor 100A according to a second variation will be described with reference to FIGS. 24 and 25.

In the capacitor 100A according to the second variation, two first external electrodes 1A are connected to each other via a first metal layer 11A, and two second external electrodes 2A are connected to each other via a second metal layer 12A.

The capacitor 100A according to the second variation allows currents to flow in opposite directions, as shown by arrows in a first external electrode 1A and a second external electrode 2A in FIG. 25.

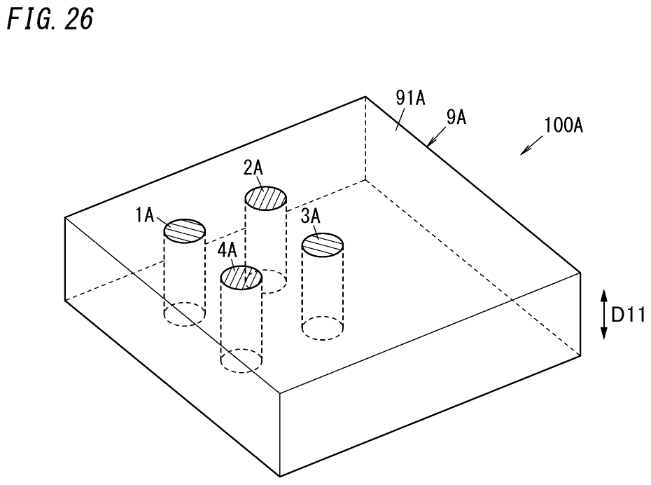

A capacitor 100A, as another example of the capacitor 100A according to the second variation, includes not only a first external electrode 1A and a second external electrode 2A but also a third external electrode 3A and a fourth external electrode 4A, as shown in FIG. 26. In the capacitor 100A as the other example shown in FIG. 26, for example, the first external electrode 1A, the second external electrode 2A, the third external electrode 3A, and the fourth external electrode 4A are used as a first anode, a first cathode, a second anode, and a second cathode, respectively. In the example of FIG. 26, the plurality of metal layers include a plurality of first metal layers, a plurality of second metal layers, a plurality of third metal layers, and a plurality of fourth metal layers. The plurality of first metal layers are connected to the first external electrode 1A and disposed away from the second external electrode 2A, the third external electrode 3A, and the fourth external electrode 4A. The plurality of first metal layers are arranged apart from each other in the thickness direction D11. The plurality of second metal layers are connected to the second external electrode 2A and disposed away from the first external electrode 1A, the third external electrode 3A, and the fourth external electrode 4A. The plurality of second metal layers are arranged apart from each other in the thickness direction D11. The plurality of third metal layers are connected to the third external electrode 3A and disposed away from the first external electrode 1A, the second external electrode 2A, and the fourth external electrode 4A. The plurality of third metal layers are arranged apart from each other in the thickness direction D11. The plurality of fourth metal layers are connected to the fourth external electrode 4A and disposed away from the first external electrode 1A, the second external electrode 2A, and the third external electrode 3A. The plurality of fourth metal layers are arranged apart from each other in the thickness direction D11. In the plurality of metal layers, each of the plurality of first metal layers is disposed in the thickness direction D11 adjacent to at least one metal layer selected form the group consisting of the plurality of third metal layers and the plurality of fourth metal layers. In the plurality of metal layers, each of the plurality of third metal layers is disposed in the thickness direction D11 adjacent to at least one metal layer selected form the group consisting of the plurality of first metal layers and the plurality of second metal layers.

### (4.3) Third Variation

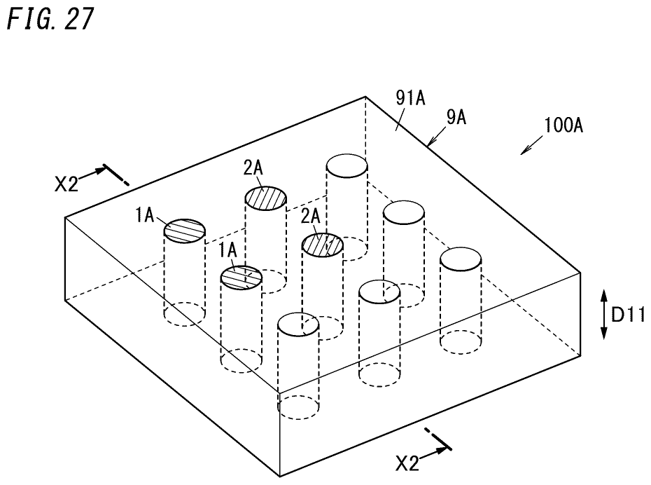

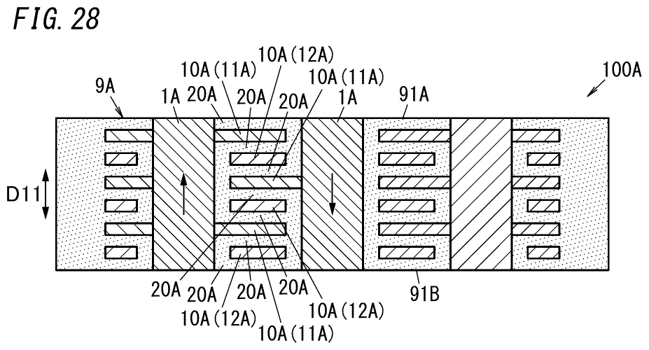

A capacitor 100A according to a third variation will be described with reference to FIGS. 27 and 28.

The capacitor 100A according to the third variation differs from the capacitor 100A according to the second embodiment in arrangements of a plurality of first external electrodes 1A and a plurality of second external electrodes 2A.

In the capacitor 100A according to the third variation, two first external electrodes 1A are not connected to each other via a first metal layer 11A, and two second external electrodes 2A are not connected to each other via a second metal layer 12A.

The capacitor 100A according to the third variation allows currents to flow in opposite directions, as shown by arrows in two first external electrodes 1A in FIG. 28.

In a capacitor as another example of the capacitor 100A according to the third variation, one of two first external electrodes 1A in FIG. 27 may be applied as a third external electrode 3A, and one of two second external electrodes 2A in FIG. 27 may be applied as a fourth external electrode 4A, similarly to the variation shown in FIG. 26.

### (4.4) Fourth Variation

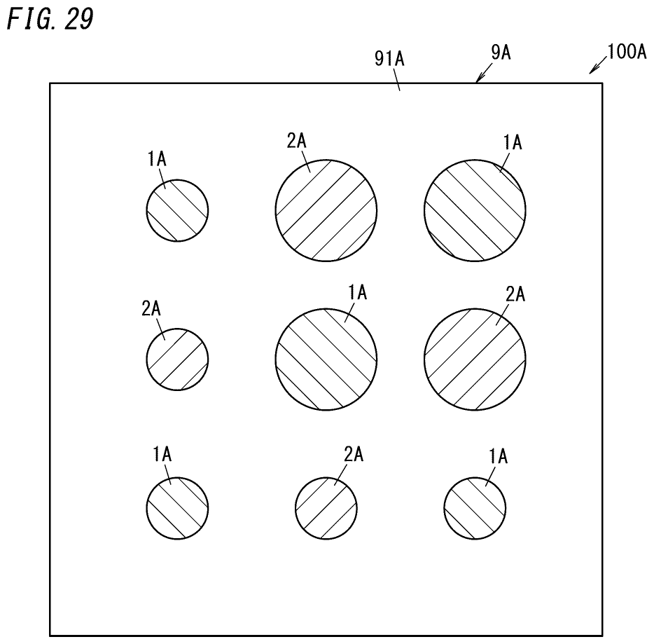

As shown in FIG. 29, a capacitor 100A according to a fourth variation differs from the capacitor 100A according to the second embodiment in that: each of diameters of a first external electrode 1A disposed in a center of a layered body 9A and a first external electrode 1A disposed in a corner of the layered body 9A, out of five first external electrodes 1A, is larger than a diameter of any of the remaining three first external electrodes 1A; and each of diameters of two second external electrodes 2A is larger than a diameter of any of the remaining two second external electrodes 2A.

With respect to a plurality of first external electrodes 1A, a first external electrode 1A having a relatively larger diameter can have a smaller resistance value than a first external electrode 1A having a relatively smaller diameter.

Also with respect to a plurality of second external electrodes 2A, a second external electrode 2A having a relatively larger diameter can have a smaller resistance value than a second external electrode 2A having a relatively smaller diameter.

### (4.5) Fifth Variation

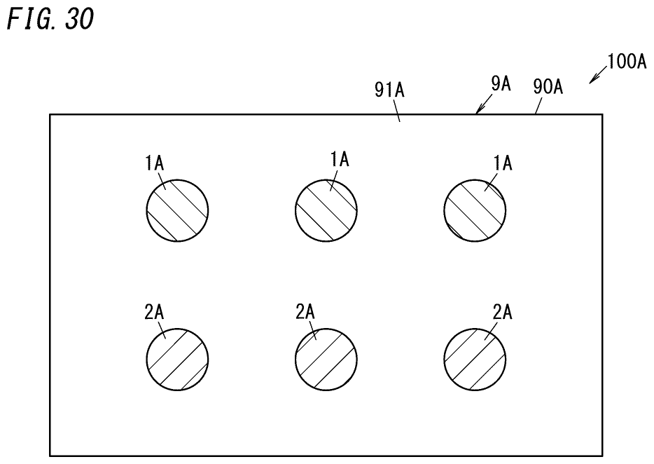

As shown in FIG. 30, a capacitor 100A according to a fifth variation differs from the capacitor 100A according to the second embodiment in that: a layered body 9A has an outer edge 90A with a rectangular shape; a plurality (e.g., three) of first external electrodes 1A are arranged in a row along one long side of the outer edge 90A of the layered body 9A; and a plurality (e.g., three) of second external electrodes 2A are arranged in a row along the other long side of the outer edge 90A of the layered body 9A.

In the capacitor 100A according to the fifth variation, each first external electrode 1A and a corresponding second external electrode 2A are adjacent to each other in a direction parallel to a short side of the outer edge 90A of the layered body 9A.

### (4.6) Sixth Variation

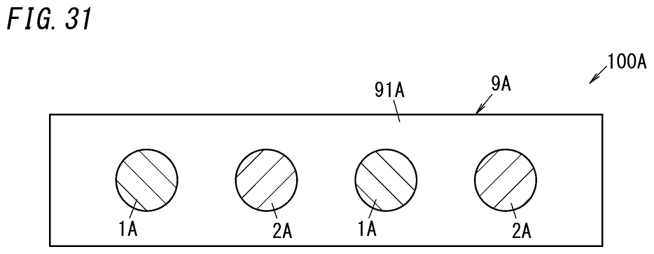

As shown in FIG. 31, a capacitor 100A according to a sixth variation differs from the capacitor 100A according to the second embodiment in that: a layered body 9A has an outer edge 90A with a rectangular shape; and a plurality of first external electrodes 1A and a plurality of second external electrodes 2A are arranged alternately in a longitudinal direction of the layered body 9A.

### (4.7) Seventh Variation

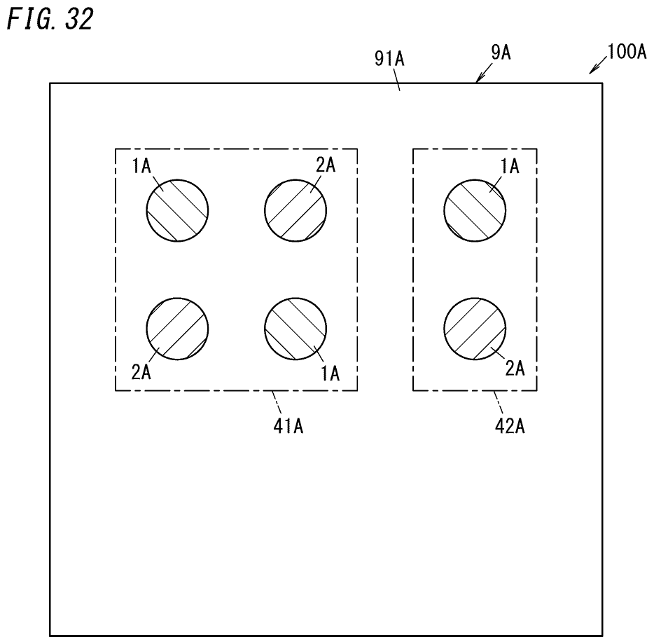

As shown in FIG. 32, a capacitor 100A according to a seventh variation differs from the capacitor 100A according to the second embodiment in that a first capacitor element 41A and a second capacitor element 42A are included. The first capacitor element 41A includes two first external electrodes 1A and two second external electrodes 2A. The second capacitor element 42A includes one first external electrode 1A and one second external electrode 2A.

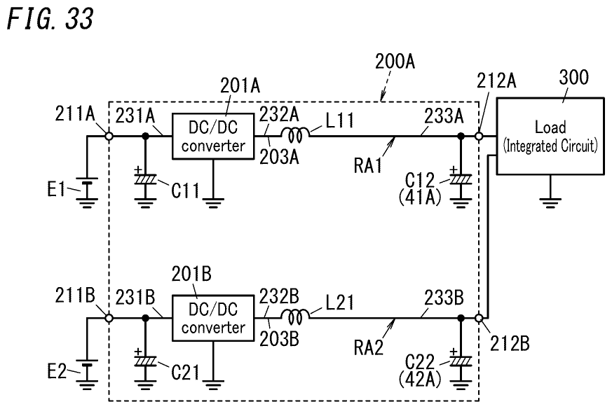

As shown in FIG. 33, a power source module 200A including the capacitor 100A according to the seventh variation includes, for example, a plurality of power supply rails for supplying voltage and current to a load 300. The plurality of power supply rails include a first power supply rail RA1 and a second power supply rail RA2. The first power supply rail RA1 includes a current path 203A from an output end of a DC/DC converter 201A (hereinafter, also referred to as a “first DC/DC converter 201A”) of a power source module 200A according to the second embodiment to the load 300. The second power supply rail RA2 includes a current path 203B from an output end of a DC/DC converter 201B (hereinafter, also referred to as a “second DC/DC converter 201B”), which is different from the first DC/DC converter 201A, to the load 300.

The power source module 200A according to the seventh variation includes the second DC/DC converter 201B described above, an inductor L21, a capacitor C21, and a capacitor C22.

The second DC/DC converter 201B converts a third DC voltage output from a DC power supply E2 into a fourth DC voltage, and outputs the fourth DC voltage thus converted. The second DC/DC converter 201B is a switching type converter. The second DC/DC converter 201B includes a switching element, and the switching element is operated at a switching frequency which is for example, equal to or more 200 kHz but equal to or less than 10 MHz. The DC power supply E2 is not a component of the power source module 200A in this variation, but this is only an example and should not be construed as limiting. Alternatively, the DC power supply E2 may be a component of the power source module 200A. The DC power supply E2 has a positive electrode and a negative electrode. The DC power supply E2 is, for example, a battery. In the power source module 200A, the positive electrode of the DC power supply E2 is connected to an input end 211B of the power source module 200A. The power source module 200A further includes a wiring part 231B connecting the input end 211B of the power source module 200A and an input end of the second DC/DC converter 201B.

The inductor L21 is provided on the current path 203B from the second DC/DC converter 201B to the load 300. The current path 203B includes: a wiring part 232B connecting the second DC/DC converter 201B and the inductor L21; and a wiring part 233B connecting the inductor L21 and an output end 212B of the power source module 200A.

The capacitor C21 is connected between the ground and the wiring part 231B that is disposed between the input end 211B of the power source module 200A and the second DC/DC converter 201B. The capacitor C21 is, for example, an electrolytic capacitor.

The capacitor C22 is connected between the wiring part 233B and the ground.

In the power source module 200A according to the seventh variation, the capacitor C12 is constituted by the first capacitor element 41A of the capacitor 100A, and the capacitor C22 is constituted by the second capacitor element 42A of the capacitor 100A. Accordingly, the first capacitor element 41A is a capacitor element for the first power supply rail RA1, and the second capacitor element 42A is a capacitor element for the second power supply rail RA2.

### Other Variations

The first and second embodiments and variations described above are only examples of various embodiments according to the present disclosure. In the first and second embodiments and variations described above, various modifications may be made depending on a design choice or any other factor, as long as the purpose of the present disclosure is achieved.

For example, in the capacitor 100 according to the first embodiment, a metal layer 10, which corresponds to any one of the plurality of first metal layers 11 and the plurality of second metal layers 12, may be configured without the first porous part 110 and/or the second porous part 120.

In the capacitor 100 according to the first embodiment, the metal foil may be a sintered foil, vapor deposition foil, or coated foil, covered with a conductive film. Examples of material of the conductive film material include Ti, TiC, TiO and C.

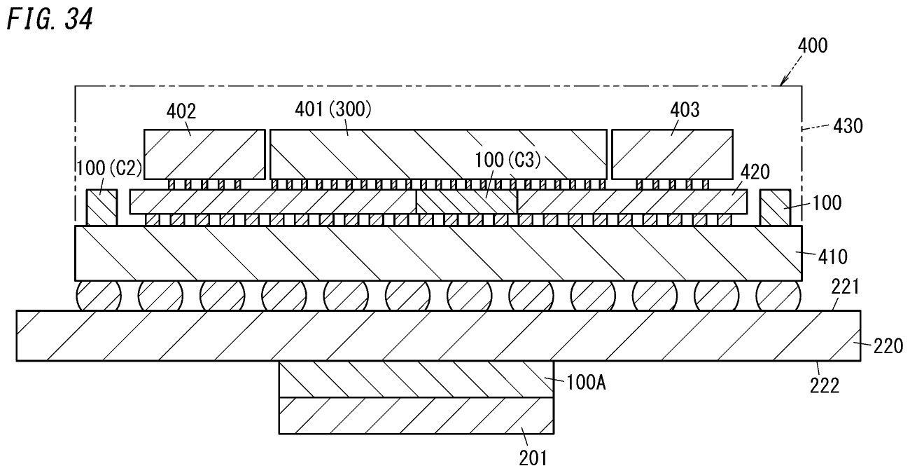

The capacitor 100 according to the first embodiment may be included in a semiconductor device 400 made of a System in Package (SiP), for example, as shown in FIG. 34. The semiconductor device 400 is mounted to a first main surface 221 of a mounting board 220 as a motherboard, for example, as shown in FIG. 34.

In the example shown in FIG. 34, the semiconductor device 400 includes a first IC chip 401, a second IC chip 402, a third IC chip 403, a package substrate 410, an interposer substrate 420, and a sealing part 430.

An integrated circuit of the first IC chip 401 is a processor. Accordingly, in the example shown in FIG. 34, the first IC chip 401 corresponds to the load 300 connected to the power source module 200 (refer to FIG. 8A) according to the first embodiment. Integrated circuits of the second IC chip 402 and the third IC chip 403 are memories (e.g., High Bandwidth Memories: HBMs).

The interposer substrate 420 is disposed between the package substrate 410 and a set of the first IC chip 401, second IC chip 402 and third IC chip 403.

The semiconductor device 400 includes a plurality (e.g., three) of capacitors 100. One of the three capacitors 100 is built in the interposer substrate 420. Also, the remaining two of the three capacitors 100 are mounted to the package substrate 410. The capacitor 100 built in the interposer substrate 420 corresponds to the capacitor C3 in the power source module 200 described above (refer to FIG. 8A). Also, one of the two capacitors 100 mounted to the package substrate 410 corresponds to the capacitor C2 in the power source module 200 described above.

In the example shown in FIG. 34, the capacitor 100A according to the second embodiment is disposed on the second main surface 222 of the mounting board 220, and the DC/DC converter 201 is stacked on the capacitor 100A.

### Aspects

A capacitor (100) according to a first aspect includes a layered body (9; 9a), a first external electrode (1), a second external electrode (2), a third external electrode (3) and a fourth external electrode (4). The layered body (9; 9a) includes a plurality of metal layers (10) and a plurality of dielectric layers (20). The plurality of metal layers (10) and the plurality of dielectric layers (20) are alternately arranged in a first direction (D1). The first external electrode (1) and the second external electrode (2) are disposed to face each other with the layered body (9; 9a) being interposed between the first external electrode (1) and the second external electrode (2) in a second direction (D2) orthogonal to the first direction (D1). The third external electrode (3) and the fourth external electrode (4) are disposed to face each other with the layered body (9; 9a) being interposed between the third external electrode (3) and the fourth external electrode (4) in a third direction (D3) orthogonal to both the first direction (D1) and the second direction (D2). The plurality of metal layers (10) include a plurality of first metal layers (11), a plurality of second metal layers (12), a plurality of third metal layers (13) and a plurality of fourth metal layers (14). The plurality of first metal layers (11) are connected to the first external electrode (1), and disposed away from the second external electrode (2). The plurality of first metal layers (11) are arranged apart from each other in the first direction (D1). The plurality of second metal layers (12) are connected to the second external electrode (2), and disposed away from the first external electrode (1). The plurality of second metal layers (12) are arranged apart from each other in the first direction (D1). The plurality of third metal layers (13) are connected to the third external electrode (3), and disposed away from the fourth external electrode (4). The plurality of third metal layers (13) are arranged apart from each other in the first direction (D1). The plurality of fourth metal layers (14) are connected to the fourth external electrode (4), and disposed away from the third external electrode (3). The plurality of fourth metal layers (14) are arranged apart from each other in the first direction (D1). In the plurality of metal layers (10), the plurality of first metal layers (11) and the plurality of second metal layers (12) are arranged in the first direction (D1), and the plurality of third metal layers (13) and the plurality of fourth metal layers (14) are arranged in the first direction (D1). In the plurality of metal layers (10), each of the plurality of first metal layers (11) is disposed in the first direction (D1) adjacent to at least one metal layer (10) selected form a group consisting of the plurality of third metal layers (13) and the plurality of fourth metal layers (14). In the plurality of metal layers (10), each of the plurality of third metal layers (13) is disposed in the first direction (D1) adjacent to at least one metal layer (10) selected form a group consisting of the plurality of first metal layers (11) and the plurality of second metal layers (12).

The capacitor (100) according to the first aspect can contribute to achieving a lower impedance thereof.

In a capacitor (100) according to a second aspect, which may be implemented in conjunction with the first aspect, the plurality of first metal layers (11) and the plurality of second metal layers (12) are arranged alternately on a layer-by-layer basis. The plurality of third metal layers (13) and the plurality of fourth metal layers (14) are arranged alternately on a layer-by-layer basis.

In a capacitor (100) according to a third aspect, which may be implemented in conjunction with the second aspect, the plurality of first metal layers (11), the plurality of third metal layers (13), the plurality of second metal layers (12) and the plurality of fourth metal layers (14) are arranged in the first direction (D1) repeatedly in an order of a first metal layer (11), a third metal layer (13), a second metal layer (12) and a fourth metal layer (14) on a layer-by-layer basis.

In a capacitor (100) according to a fourth aspect, which may be implemented in conjunction with any one of the first to third aspects, a distance (H12) between the first external electrode (1) and the second external electrode (2) in the second direction (D2) is less than a distance (H34) between the third external electrode (3) and the fourth external electrode (4) in the third direction (D3).

The capacitor (100) according to the fourth aspect can contribute to achieving a lower impedance thereof over a wider frequency band.

A capacitor (100) according to a fifth aspect, which may be implemented in conjunction with any one of the first to fourth aspects, further includes an exterior (8). The exterior (8) covers at least a part of the layered body (9; 9a). The exterior (8) has a rectangular parallelepiped outer shape. The exterior (8) includes: a first main surface (81) and a second main surface (82); a third main surface (83) and a fourth main surface (84); and a fifth main surface (85) and a sixth main surface (86). The first main surface (81) and the second main surface (82) of the exterior (8) are disposed to be opposite to each other in the second direction (D2) when viewed from the layered body (9; 9a). The third main surface (83) and the fourth main surface (84) of the exterior (8) are disposed to be opposite to each other in the third direction (D3) when viewed from the layered body (9; 9a). The fifth main surface (85) and the sixth main surface (86) of the exterior (8) are disposed to be opposite to each other in the first direction (D1) when viewed from the layered body (9; 9a). The first external electrode (1) is disposed over the first main surface (81), the fifth main surface (85) and the sixth main surface (86) of the exterior (8). The second external electrode (2) is disposed over the second main surface (82), the fifth main surface (85) and the sixth main surface (86) of the exterior (8). The third external electrode (3) is disposed over the third main surface (83), the fifth main surface (85) and the sixth main surface (86) of the exterior (8). The fourth external electrode (4) is disposed over the fourth main surface (84), the fifth main surface (85) and the sixth main surface (86) of the exterior (8).

In a capacitor (100) according to a sixth aspect, which may be implemented in conjunction with any one of the first to fifth aspects, the plurality of metal layers (10) further includes a fifth metal layer (15). The fifth metal layer (15) is positioned at one of both ends of the layered body (9; 9a) in the first direction (D1). The fifth metal layer (15) is connected to both the third external electrode (3) and the fourth external electrode (4), and disposed away from the first external electrode (1) and the second external electrode (2).

In the capacitor (100) according to the sixth aspect, the fifth metal layer (15) can function as a shielding layer, for example, by connecting the third external electrode (3) and the fourth external electrode (4) to the ground.

In a capacitor (100) according to a seventh aspect, which may be implemented in conjunction with any one of the first to sixth aspects, the layered body (9; 9a) includes a plurality of capacitor elements (40). Each of the plurality of capacitor elements (40) includes: two metal layers (10), adjacent to each other in the first direction (D1), of the plurality of metal layers (10); and a single dielectric layer (20), positioned between the two metal layers (10), of the plurality of dielectric layers (20). Each of the plurality of capacitor elements (40) further includes a solid electrolyte layer (30) interposed between the single dielectric layer (20) and one of the two metal layers (10).

In a capacitor (100) according to an eighth aspect, which may be implemented in conjunction with any one of the first to seventh aspects, the layered body (9a) includes a plurality of capacitor elements (40). Each of the plurality of capacitor elements (40) includes: two metal layers (10), adjacent to each other in the first direction (D1), of the plurality of metal layers (10); and a single dielectric layer (20), positioned between the two metal layers (10), of the plurality of dielectric layers (20). The plurality of capacitor elements (40) includes a first capacitor element (41) and a second capacitor element (42). The first capacitor element (41) and the second capacitor element (42) are arranged in an order of the first capacitor element (41) and the second capacitor element (42) in the first direction (D1). The first capacitor element (41) has a capacitance, and the second capacitor element (42) has a capacitance larger than the capacitance of the first capacitor element (41).

The capacitor (100) according to the eighth aspect can contribute to achieving a lower impedance thereof over a wider frequency band.

A capacitor (100A) according to a ninth aspect includes a layered body (9A), a plurality of first external electrodes (1A) and a plurality of second external electrodes (2A). The layered body (9A) includes a plurality of metal layers (10A) and a plurality of dielectric layers (20A). The plurality of metal layers (10A) and the plurality of dielectric layers (20A) are alternately arranged in a thickness direction (D11) of the layered body (9A). All of the plurality of first external electrodes (1A) and the plurality of second external electrodes (2A) are disposed to penetrate the layered body (9A) in the thickness direction (D11) of the layered body (9A). The plurality of metal layers (10A) includes a plurality of first metal layers (11A) and a plurality of second metal layers (12A). The plurality of first metal layers (11A) are connected to the plurality of first external electrodes (1A), and disposed away from the plurality of second external electrodes (2A). The plurality of first metal layers (11A) are arranged apart from each other in the thickness direction (D11) of the layered body (9A). The plurality of second metal layers (12A) are connected to the plurality of second external electrodes (2A), and disposed away from the plurality of first external electrodes (1A). The plurality of second metal layers (12A) are arranged apart from each other in the thickness direction (D11) of the layered body (9A). In the plurality of metal layers (10A), the plurality of first metal layers (11A) and the plurality of second metal layers (12A) are arranged alternately on a layer-by-layer basis in the thickness direction (D11) of the layered body (9A).

The capacitor (100A) according to the ninth aspect can contribute to achieving a lower impedance thereof.

A power source module (200; 200A) according to a tenth aspect includes: a DC/DC converter (201; 201A); an inductor (L1; L11), the capacitor (100; 100A) of any one of the first to ninth aspects. The inductor (L1; L11) is connected to an output end of the DC/DC converter (201; 201A). The capacitor (100; 100A) is connected between ground and a wiring part (233; 233A) that is disposed between the inductor (L1; L11) and a load (300).

The power source module (200; 200A) according to the tenth aspect can contribute to achieving a lower impedance of the capacitor.

### REFERENCE SIGNS LIST

1 First external electrode
1A First external electrode
2 Second external electrode
2A Second external electrode
3 Third external electrode
4 Fourth external electrode
5 First insulating film
6 Second insulating film
7 Substrate
71 First main surface
72 Second main surface
8 Exterior
81 First main surface
82 Second main surface
83 Third main surface
84 Fourth main surface
85 Fifth main surface
86 Sixth main surface
9, 9a, 9A Layered body
10 Metal layer
101 First main surface
102 Second main surface
110 First porous part
110A Surface
112 Hole
120 Second porous part
120A Surface
122 Hole
11, 11A First metal layer
111A First part
111B Second part
12, 12A Second metal layer
121A First part
121B Second part
13 Third metal layer
14 Fourth metal layer
15 Fifth metal layer
20 Dielectric layer
30 Solid electrolyte layer
40 Capacitor element
41 First capacitor element
42 Second capacitor element
43 Third capacitor element
50 Adhesion layer
100, 100A Capacitor
200, 200A Power source module
201, 201A DC/DC converter
C1 Capacitor
C2 Capacitor
C3 Capacitor
C11 First capacitor
C12 Second capacitor
C21 Capacitor
C22 Capacitor
L1, L11 Inductor
231, 231A Wiring part
232, 232A Wiring part
233, 233A Wiring part
300 Load
D0 Thickness direction
D1 First direction
D2 Second direction
D3 Third direction
D11 Thickness direction

1. A capacitor comprising:
a layered body including a plurality of metal layers and a plurality of dielectric layers, the plurality of metal layers and the plurality of dielectric layers being alternately arranged in a first direction;
a first external electrode and a second external electrode disposed to face each other with the layered body being interposed between the first external electrode and the second external electrode in a second direction orthogonal to the first direction; and
a third external electrode and a fourth external electrode disposed to face each other with the layered body being interposed between the third external electrode and the fourth external electrode in a third direction orthogonal to both the first direction and the second direction,
the plurality of metal layers including
a plurality of first metal layers connected to the first external electrode, and disposed away from the second external electrode, the plurality of first metal layers being arranged apart from each other in the first direction,
a plurality of second metal layers connected to the second external electrode, and disposed away from the first external electrode, the plurality of second metal layers being arranged apart from each other in the first direction,
a plurality of third metal layers connected to the third external electrode, and disposed away from the fourth external electrode, the plurality of third metal layers being arranged apart from each other in the first direction, and
a plurality of fourth metal layers connected to the fourth external electrode, and disposed away from the third external electrode, the plurality of fourth metal layers being arranged apart from each other in the first direction,
in the plurality of metal layers,
the plurality of first metal layers and the plurality of second metal layers being arranged in the first direction,
the plurality of third metal layers and the plurality of fourth metal layers being arranged in the first direction,
each of the plurality of first metal layers being disposed in the first direction adjacent to at least one metal layer selected form a group consisting of the plurality of third metal layers and the plurality of fourth metal layers, and
each of the plurality of third metal layers being disposed in the first direction adjacent to at least one metal layer selected form a group consisting of the plurality of first metal layers and the plurality of second metal layers.

2. The capacitor of claim 1, wherein
the plurality of first metal layers and the plurality of second metal layers are arranged alternately on a layer-by-layer basis, and
the plurality of third metal layers and the plurality of fourth metal layers are arranged alternately on a layer-by-layer basis.

3. The capacitor of claim 2, wherein
the plurality of first metal layers, the plurality of third metal layers, the plurality of second metal layers and the plurality of fourth metal layers are arranged in the first direction repeatedly in an order of a first metal layer, a third metal layer, a second metal layer and a fourth metal layer on a layer-by-layer basis.

4. The capacitor of claim 1, wherein
a distance between the first external electrode and the second external electrode in the second direction is less than a distance between the third external electrode and the fourth external electrode in the third direction.

5. The capacitor of claim 1, further comprising an exterior covering at least a part of the layered body, the exterior having a rectangular parallelepiped outer shape, wherein
the exterior includes:
a first main surface and a second main surface disposed to be opposite to each other in the second direction when viewed from the layered body;
a third main surface and a fourth main surface disposed to be opposite to each other in the third direction when viewed from the layered body; and
a fifth main surface and a sixth main surface disposed to be opposite to each other in the first direction when viewed from the layered body,
the first external electrode is disposed over the first main surface, the fifth main surface and the sixth main surface,
the second external electrode is disposed over the second main surface, the fifth main surface and the sixth main surface,
the third external electrode is disposed over the third main surface, the fifth main surface and the sixth main surface, and
the fourth external electrode is disposed over the fourth main surface, the fifth main surface and the sixth main surface.

6. The capacitor of claim 1, wherein
the plurality of metal layers further includes a fifth metal layer positioned at one of both ends of the layered body in the first direction, and
the fifth metal layer is connected to both the third external electrode and the fourth external electrode, and disposed away from the first external electrode and the second external electrode.

7. The capacitor of claim 1, wherein
the layered body includes a plurality of capacitor elements, each of which includes:
two metal layers, adjacent to each other in the first direction, of the plurality of metal layers; and
a single dielectric layer, positioned between the two metal layers, of the plurality of dielectric layers, and
each of the plurality of capacitor elements further includes a solid electrolyte layer interposed between the single dielectric layer and one of the two metal layers.

8. The capacitor of claim 1, wherein
the layered body includes a plurality of capacitor elements, each of which includes:
two metal layers, adjacent to each other in the first direction, of the plurality of metal layers; and
a single dielectric layer, positioned between the two metal layers, of the plurality of dielectric layers, and
the plurality of capacitor elements includes
a first capacitor element having a capacitance, and
a second capacitor element having a capacitance larger than the capacitance of the first capacitor element,
the first capacitor element and the second capacitor element are arranged in an order of the first capacitor element and the second capacitor element in the first direction.

9. A capacitor comprising:
a layered body including a plurality of metal layers and a plurality of dielectric layers, the plurality of metal layers and the plurality of dielectric layers being alternately arranged in a thickness direction of the layered body; and
a plurality of first external electrodes and a plurality of second external electrodes, all of which are disposed to penetrate the layered body in the thickness direction of the layered body,
the plurality of metal layers including
a plurality of first metal layers connected to the plurality of first external electrodes, and disposed away from the plurality of second external electrodes, the plurality of first metal layers being arranged apart from each other in the thickness direction of the layered body, and
a plurality of second metal layers connected to the plurality of second external electrodes, and disposed away from the plurality of first external electrodes, the plurality of second metal layers being arranged apart from each other in the thickness direction of the layered body, and
in the plurality of metal layers, the plurality of first metal layers and the plurality of second metal layers being arranged alternately on a layer-by-layer basis in the thickness direction of the layered body.

10. A power source module comprising:
a DC/DC converter;
an inductor connected to an output end of the DC/DC converter; and
the capacitor of claim 1, the capacitor being connected between ground and a wiring part that is disposed between the inductor and a load.

11. A power source module comprising:
a DC/DC converter;
an inductor connected to an output end of the DC/DC converter; and
the capacitor of claim 9, the capacitor being connected between ground and a wiring part that is disposed between the inductor and a load.
